(19) United States
(12) Patent Application Publication
(10) Pub. No.: US 2006/0129445 A1
(43) Pub. Date: Jun. 15, 2006

(54) System and method for scheduling a litigation event

(76) Inventor: Rodney H. McCallum JR., Jupiter, FL (US)

Correspondence Address: RUDEN, MCCLOSKY, SMITH, SCHUSTER & RUSSELL, P.A., 222 LAKEVIEW AVE, SUITE 800, WEST PALM BEACH, FL, 33401-6112, US

(21) Appl. No.: 11/232,138

(22) Filed: Sep. 21, 2005

Related U.S. Application Data
(60) Provisional application No. 60/634,861, filed on Dec. 9, 2004.

(51) Int. Cl. G06F 9/46

(52) U.S. Cl. 705/8

(57) ABSTRACT

A system and method for scheduling witness depositions and other litigation-related events has been developed. The computer communications network-based system provides improved systems and methods that are more efficient and less costly than currently available scheduling systems and methods.

### CROSS REFERENCE TO RELATED APPLICATION

The present application claims the priority of U.S. provisional patent application No. 60/634,861, filed Dec. 9, 2004.

### FIELD OF THE INVENTION

The invention relates generally to the fields of information technology and law. More particularly, the invention relates to a system for scheduling witness depositions or similar events encountered in litigation.

### BACKGROUND

The inefficiency of conventional methods for scheduling a litigation event such as a witness deposition, sworn statement, unsworn statement, examination under oath, independent medical examination, hearing, pre-trial conference, mediation, or trial leads to a tremendous waste of resources and lost productivity. Conventionally, an attorney's assistant attempting to schedule a litigation event must contact and then coordinate a time and place to conduct the event that is acceptable to a multitude of parties such as two or more attorneys, expert witnesses, mediators and/or judges. In addition, a non-expert witness or witnesses, a process server, a court reporter, a videographer, and an interpreter (if necessary) could be ordered to appear or to perform services. This method typically involves the assistant placing a telephone call to each of the foregoing attorneys, expert witnesses, mediators and/or judges seeking several different dates/times that the parties are available. Repeated telephone calls are often required where no mutually convenient time/date for conducting the event is found. The more parties involved, the more complicated and involved this process can be. In complex, multi-party litigation this process can be daunting. And, as is often the case, where one party later cancels the event due to a conflict or the scheduled or subpoenaed witness(es) does not appear at the agreed or assigned date, time and location, the process of scheduling the event must be started again from the beginning. Further complicating this, conventional methods of scheduling a litigation event are inherently prone to mistakes caused by human error.

### SUMMARY

The invention relates to the development of a computer communications network-based system for scheduling a litigation event that increases worker efficiency, reduces costs, and minimizes errors. The system can be securely accessible by attorneys, attorney assistants (e.g., paralegals, secretaries), law firms, administrators, expert witnesses, mediators, court reporters, process servers, interpreters, videographers, judicial assistants, court personnel (e.g., clerks, judges, etc.), and others so that each can work together to efficiently schedule a litigation event.

Accordingly, the invention features a system for scheduling a deposition of a witness during a litigation. This system includes at least one server communicatively connected to a computer communications network, the at least one server including at least one database having stored therein data relating to the witness deposition, the data including the name of an attorney or law firm representing a plaintiff in the litigation, the name of an attorney or law firm representing a defendant in the litigation, information identifying the litigation, the name of the witness, and a proposed date and time for conducting the witness deposition, the at least one server configured to receive input signals from and transmit output signals across the computer communications network to a network access device of at least a first system user acting for the attorney or law firm representing a defendant and to a network access device of a second system user acting for the attorney or law firm representing a plaintiff, wherein at least a portion of the data stored in the database, including the proposed date and time for conducting the witness deposition, can be modified by the first system user and the second system user via the input signals conveyed across the computer communications network, the server further including at least one database having stored therein the calendar schedules of a plurality of attorneys including at least the attorney representing a plaintiff and the attorney representing a defendant, the system further including a processor configured to compare the calendar schedules of a plurality of attorneys and determine at least one date and time (e.g., at least three dates and times) that all of the plurality of attorneys are available to attend the witness deposition. The processor can be configured to: register a new user of the system and to restrict unregistered users from accessing the system, compare a digital signature stored on the database with a digital signature on a document to determine authenticity of the document, export and synchronize data and files stored in the database with other servers communicatively connected to the computer communications network, import data and files stored in a database on at least one of the other servers, send a signal to a user's network access device indicating that a change has been made to the proposed date and time for conducting the witness deposition, and synchronize with a calendaring software program resulting in information pertaining to a particular user stored in the database being updated when that user logs on to the system.

Within the invention is a system for scheduling a deposition of a witness during a litigation that includes at least one server communicatively connected to a computer communications network, the at least one server including at least one database having stored therein data relating to the witness deposition, the data including a name of an attorney or law firm representing a plaintiff in the litigation, a name of an attorney or law firm representing a defendant in the litigation, information identifying the litigation, a name of the witness, a proposed date and time for conducting the witness deposition, and a proposed location for conducting the deposition, the at least one server being configured to receive input signals from and to transmit output signals across the computer communications network to a network access device of at least a first system user acting for the attorney or law firm representing a defendant and a network access device of a second system user acting for the attorney or law firm representing a plaintiff, wherein at least a portion of the data stored in the database, including the proposed date and time for conducting the witness deposition, can be modified by the first system user and the second system user via the input signals conveyed across the computer communications network. In this system, the at least one server can be configured to receive input signals from and transmit output signals to a network access device of at least one additional system user (e.g., an expert witness, a mediator, a judge, a judicial assistant, a court clerk, a process server, a court reporter, a videographer, and an interpreter). The at least one additional system user can be a vendor such as a court reporter, a process server, a videographer, an interpreter, and a mediator, as well as a court official such as a judge, a judicial assistant, and a court clerk. The at least one server can be further configured to receive input signals from and transmit output signals to a network access device of an insurance company representative. In this system, the computer communications network is the Internet and the first system user is located at least 1 kilometer from the second system user. The data stored in the database can further include at least three of: the name of the presiding judge, contact information for the attorney representing a plaintiff, contact information for the attorney representing a defendant, the name of the court at which the litigation is pending, the address of the court, official court documents relating to the litigation, and a law firm's (e.g., a law firm representing a plaintiff in the litigation or a defendant in the litigation) internal file number pertaining to the litigation. The data stored in the database can further include directions to the proposed location of the deposition and/or a map of an area surrounding the proposed location of the deposition. Data stored in the database can also include forms for use in the litigation and rules of practice that relate to the litigation. The server can further include at least one database having stored therein compilations of names of at least 100 attorneys, contact information for the attorneys, and areas of practice for the attorneys. The database can also have stored therein compilations of names of at least 15 expert witnesses, contact information for the expert witnesses, and areas of expertise of the expert witnesses, as well as the calendar schedule of at least one expert witness. The server can further include at least one database having stored therein the calendar schedules of a plurality of attorneys, including at least the attorney representing a plaintiff and the attorney representing a defendant.

In another aspect, the invention features a method for scheduling a witness deposition. This method includes the steps of (a) providing at least one server communicatively connected to a computer communications network, the at least one server including at least one database configured to store data relating to the witness deposition, the data including (i) a name of an attorney or law firm representing a plaintiff in the litigation, (ii) a name of an attorney or law firm representing a defendant in the litigation, (iii) information identifying the litigation, (iv) a name of the witness, (vi) a proposed location for conducting the deposition, wherein the at least one server is configured to receive input signals from and to transmit output signals across the computer communications network to a network access device of at least a first system user acting for the attorney or law firm representing a defendant and a network access device of a second system user acting for the attorney or law firm representing a plaintiff, wherein at least a portion of the data stored in the database, including the proposed date and time for conducting the witness deposition, can be modified by the first system user and the second system user via the input signals conveyed across the computer communications network; (b) accepting at the server an input signal transmitted across the communications network from the first system user, the input signal including data such as (i) the name of an attorney or law firm representing a plaintiff in the litigation, (ii) the name of an attorney or law firm representing a defendant in the litigation, (iii) the information identifying the litigation, and (iv) the name of the witness, and storing the data included in the input signal in the database; (c) transmitting from the server an output signal including the data included in the input signal and the at least one proposed date and time for the witness deposition across the communications network to the second system user; and (d) accepting at the server input signals across the computer communications network from the second system user, and modifying the data stored in the database in accord with the input signals from the second system user. In this method, the at least one server is configured to receive input signals from and transmit output signals to a network access device of at least one additional system user (e.g., an expert witness, a mediator, a judge, a judicial assistant, a court clerk, a process server, a court reporter, a videographer, and an interpreter). The at least one additional system user can be a vendor such as a court reporter, a process server, a videographer, an interpreter, and a mediator. The at least one additional system user can be a court official such as a judge, a judicial assistant, and a court clerk. The at least one server can be further configured to receive input signals from and transmit output signals to a network access device of an insurance company representative. The computer communications network can be the Internet and the first system user can be located at least 1 kilometer from the second system user. Data stored in the database can further include at least three of: the name of the presiding judge, contact information for the attorney representing a plaintiff, contact information for the attorney representing a defendant, the name of the court at which the litigation is pending, the address of the court, official court documents relating to the litigation, and a law firm's (e.g., a law firm representing a plaintiff in the litigation or a defendant in the litigation) internal file number pertaining to the litigation. Data stored in the database can further include directions to the proposed location of the deposition, and/or a map of an area surrounding the proposed location of the deposition, as well as forms for use in the litigation and rules of practice that relate to the litigation. The server can further include at least one database having stored therein compilations of names of at least 100 attorneys, contact information for the attorneys, and areas of practice for the attorneys. The server can also include at least one database having stored therein compilations of names of at least 15 expert witnesses, contact information for the expert witnesses, and areas of expertise of the expert witnesses.

Another method within the invention for scheduling a witness deposition includes the steps of: (a) providing at least one server communicatively connected to a computer communications network, the at least one server including at least one database configured to store data relating to the witness deposition, the data including (i) a name of an attorney or law firm representing a plaintiff in the litigation, (ii) a name of an attorney or law firm representing a defendant in the litigation, (iii) information identifying the litigation, (iv) a name of the witness, (v) at least one proposed date and time for conducting the witness deposition, and (vi) a proposed location for conducting the deposition, the at least one server being configured to receive input signals from and to transmit output signals across the computer communications network to a network access device of at least a first system user acting for the attorney or law firm representing a defendant and a network access device of a second system user acting for the attorney or law firm representing a plaintiff, wherein at least a portion of the data stored in the database, including the proposed date and time for conducting the witness deposition, can be modified by the first system user and the second system user via the input signals conveyed across the computer communications network, wherein the server further includes at least one database having stored therein the calendar schedules of a plurality of attorneys including at least the attorney representing a plaintiff and the attorney representing a defendant, and a processor configured to compare the calendar schedules of the plurality of attorneys and determine at least one date and time that all of the plurality of attorneys are available to attend the witness deposition; (b) accepting at the server an input signal transmitted across the communications network from the network device of the first system user, the input signal including data such as (i) the name of an attorney or law firm representing a plaintiff in the litigation, (ii) the name of an attorney or law firm representing a defendant in the litigation, (iii) the information identifying the litigation, and (iv) the name of the witness, and storing the data included in the input signal in the database; (c) comparing the calendar schedules of the plurality of attorneys and determining at least one date and time that all of the plurality of attorneys have available to attend the witness deposition; and (d) transmitting from the server across the computer communications network to network access devices of the plurality of attorneys output signals including the at least one date and time that all of the plurality of attorneys have available to attend the witness deposition. An alternative method can further include the steps of (e) accepting at the server an input signal transmitted across the computer communications network from the network access device of at least one attorney of the plurality of attorneys, the input signal including an indication that the at least one attorney is unable to attend the witness deposition on the at least one date and at the at least one time and a request from the at least one attorney for a rescheduling of the witness deposition; (f) transmitting from the server across the computer communications network to network access devices of the plurality of attorneys output signals including the indication that the at least one attorney of the plurality of attorneys is unable to attend the witness deposition and the request by the at least one attorney of the plurality of attorneys to reschedule the witness deposition; (g) comparing the calendar schedules of the plurality of attorneys and determining at least a second date and time that all of the plurality of attorneys have available to attend the witness deposition; and (h) transmitting from the server across the computer communications network to network access devices of the plurality of attorneys output signals including the at least second date and time that all of the plurality of attorneys have available to attend the witness deposition. This method can also include the steps of (e) accepting at the server an input signal transmitted across the computer communications network from the network access device of at least one attorney of the plurality of attorneys, the input signal including a request from the at least one attorney to cancel the witness deposition; and (f) transmitting from the server across the computer communications network to network access devices of the plurality of attorneys output signals including the request by the at least one attorney of the plurality of attorneys to cancel the witness deposition.

Advantages provided by the system are numerous and include increases in efficiency and productivity. The system eliminates the vast amounts of time taken to coordinate the logistics of depositions and mediations through traditional methods of telephones, faxes, postal mail and even e-mail. Productivity increases through organization and execution of tasks, enabling attorneys and their assistants to accomplish more work in less time. Use of the system eliminates the need for using the telephone to contact other assistants and legal service vendors and therefore reduces the amount of time spent leaving voice mails and returning phone calls. The system also increases efficiency by providing a method of ordering transcripts from court reporters and videotapes from videographers and acknowledgement of receiving these items electronically thereby reducing ordering errors and providing a definitive proof of ordering and delivery. Another way in which the system increases efficiency is by providing a means for assistants to create redundant forms such as subpoenas, notices of deposition, etc., thereby reducing errors resulting from creating such forms. Because use of the system increases efficiency, reduces errors and reduces the amount of paper used in the office due to the electronic nature of the system, it reduces operating costs for law firms and therefore increases their profit margins. The system further increases profit margins by allowing assistants (e.g., secretaries, paralegals) to perform more billable work for the law firm as opposed to scheduling or ordering tasks which are deemed as non-billable work. With regard to judges and judicial assistants, the system organizes and eliminates vast amounts of paperwork, creating efficiency and reducing costs for the county, state and federal government judicial branches which have become increasingly overburdened.

As used herein, the phrase “computer communications network” means a group of two or more computer systems communicatively linked together. For example, a “local area network” or “LAN” is a computer communications network where the linked computers are geographically close together (e.g., in the same building). A “wide area network” or “WAN” is another computer communications network similar to a LAN except that the linked computers are farther apart (e.g., they are in different buildings and connected by telephone lines or radio waves). A “global” computer communications network is one that is not limited to a certain geographical area or number of individual computers, but rather links computers throughout the world generally without restriction. The Internet is an example of a global computer communications network.

When used as a verb herein, the phrases “electronic mail” or “e-mail” means to transmit one or more messages over a computer communications network. When used as a noun, these phrases mean a message transmitted over a computer communications network. The messages can be, e.g., notes entered from a keyboard or electronic files stored on disk. By the phrase “electronic post office box” or “electronic mailbox” is meant an area in memory or on a storage device where e-mail is placed. An “electronic mailbox address” or “e-mail address” is a name that identifies an electronic post office box on a network where e-mail can be sent. For example, on the Internet, all e-mail addresses presently have the form: <name>@<domain name>.

As used herein, the term “server” means a computer or device on a network that manages network resources, e.g., processes data coming in from a computer communications network, stores files in a database, and outputs files from a database over the computer communications network. Examples of servers include file servers, e-mail servers, and web servers.

By the term “Web browser,” or simply “browser,” is meant a software application that enables one to access and use the facilities of a Web site or server, e.g., to locate and display Web pages or data.

“Computer program” and “program” mean a writing that sets forth instructions that can direct the operation of an automatic system capable of storing, processing, retrieving, or transferring information. When a computer program is entered into a computer system, it forms part of the system referred to as “software.” By the term “hardware” is meant physical components of a computer system.

As used herein, a “Web site” is a site (location) on a computer communications network such as the Internet containing one or more Web pages. Most Web sites contain a “home page,” which is the main page of a Web site and usually the first screen users see when they enter the site. Home pages often offer an introduction to the material contained in the Web site and also an index or table of contents hyperlinked to related Web page documents of the site. By the phrase “Web page” is meant a document published on a computer communications network.

By the term “user” is meant any individual or entity who accesses or uses the system of the invention.

Unless otherwise defined, all technical and legal terms used herein have the same meaning as commonly understood by one of ordinary skill in the art to which this invention belongs. Although methods and materials similar or equivalent to those described herein can be used in the practice or testing of the present invention, suitable methods and materials are described below. All patent applications mentioned herein are incorporated by reference in their entirety. In case of conflict, the present specification, including definitions, will control. In addition, the particular embodiments discussed below are illustrative only and not intended to be limiting. Other features and advantages of the invention will be apparent from the following detailed description, and from the claims.

### BRIEF DESCRIPTION OF THE DRAWINGS

FIG. 1 is block diagram of a system of the invention.

FIG. 2 is a flowchart of an exemplary system of the invention.

FIG. 3 is a screen shot of an aspect of the invention.

FIG. 4 is a screen shot of an aspect of the invention.

FIG. 5 is a screen shot of an aspect of the invention.

FIG. 6 is a screen shot of an aspect of the invention.

FIG. 7 is a screen shot of an aspect of the invention.

FIG. 8 is a screen shot of an aspect of the invention.

FIG. 9 is a screen shot of an aspect of the invention.

FIG. 10 is a screen shot of an aspect of the invention.

FIG. 11 is a screen shot of an aspect of the invention.

FIG. 12 is a screen shot of an aspect of the invention.

FIG. 13 is a screen shot of an aspect of the invention.

FIG. 14 is a screen shot of an aspect of the invention.

FIG. 15 is a screen shot of an aspect of the invention.

FIG. 16 is a screen shot of an aspect of the invention.

FIG. 17 is a screen shot of an aspect of the invention.

FIG. 18 is a screen shot of an aspect of the invention.

FIG. 19 is a screen shot of an aspect of the invention.

FIG. 20 is a screen shot of an aspect of the invention.

FIG. 21 is a screen shot of an aspect of the invention.

FIG. 22 is a screen shot of an aspect of the invention.

FIG. 23 is a screen shot of an aspect of the invention.

FIG. 24 is a screen shot of an aspect of the invention.

FIG. 25 is a diagram illustrating a number of uses for a system of the invention.

FIG. 26 is a diagram illustrating a number of uses for a system of the invention.

### DETAILED DESCRIPTION

The invention encompasses computer communications network-based systems, software, devices, and methods for scheduling events encountered in litigation such as witness depositions, examinations under oath, sworn statements, independent medical examinations, hearings, pre-trial conferences, mediations, trials or other litigation events that require scheduling between two or more parties. The systems of the invention allow a multitude of different types of parties to conveniently interface to schedule a litigation event. The below described preferred embodiments illustrate adaptations of the various aspects of the invention. Nonetheless, from the description of these embodiments, other aspects of the invention can be made and/or practiced.

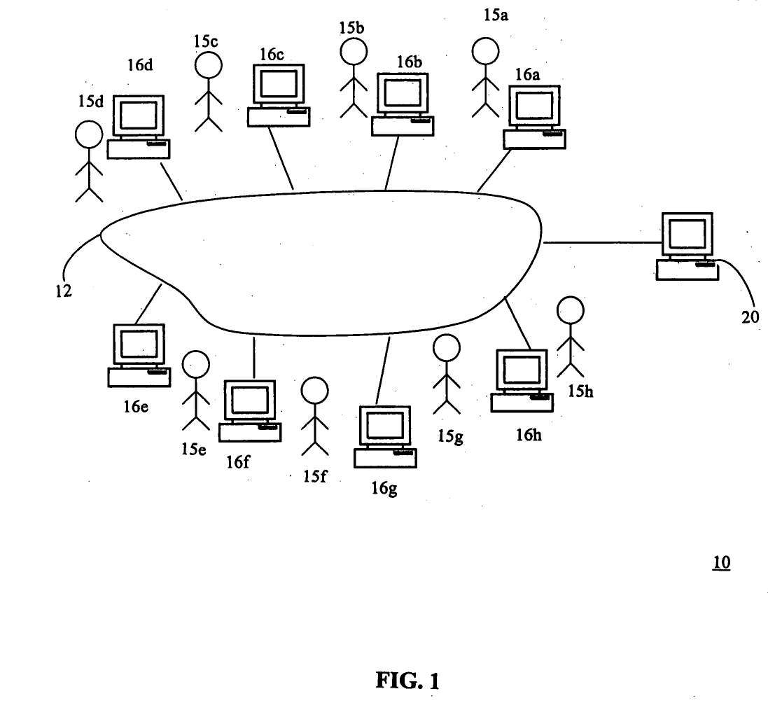

In brief overview, referring to FIG. 1, a system for scheduling a litigation event 10 connects users 15a-h from different segments of the legal industry (e.g., an attorney 15a, attorney's assistant, expert witness 15b, a judge 15c, an interpreter 15d, a videographer 15e, a court reporter 15f, a process server 15g, and a mediator 15h) through a server 20 connected to a computer communications network 12 (e.g., the Internet or a WAN). The server 20 can be accessed by users 15a-h via computer communications network access devices 16a-h (e.g., personal computers, personal digital assistants, and cellular telephones) in communication with the network 12. The server 20 can include one or more databases and one or more processors arranged to run software (e.g., CGI script) for processing inputs from devices 16a-h. Devices 16a-h included in the system 10 can be configured to run browsers that allow communication with the server 20. Although general purpose browsers such as Internet Explorer™ or Mozilla Firefox™ might be used, for added security, a browser specifically designed for use with the system 10 is preferred. To suit the needs of particular system user types, browsers for use with the system are preferably configurable to access and display system data in different formats according to user type (e.g., different configurations for the attorney 15a, the attorney's assistant, the expert witness 15b, the judge 15c, the interpreter 15d, the videographer 15e, the court reporter 15f, the process server 15g, and the mediator 15h).

In the system shown in FIG. 1, a user 15 can interact over the computer communications network 12 with the server 20 to initiate the scheduling of a litigation event or to respond to another user's request to schedule a litigation event. If the user 15 is initiating the event, the user 15 can enter a new event into the system 10 by inputting data into the server 20. Such data can include the names and contact information (e.g., e-mail addresses) of the parties to be contacted, the type of event, and suggested times/dates/places to conduct the litigation event. If the user 15 is a non-initiating party and a new event has already been entered into the system 10, the user 15 can communicate with the server 20 to indicate which of the suggested times/dates/places are acceptable or that none of the suggested times/dates/places are acceptable. In the latter situation, the server 20 can be configured to query the user 15 to suggest several additional times/dates/places that the user 15 is available. The non-initiating party can reject the suggested time/date/place, thereby requiring the initiating party to choose another available date/time/place to once again present to the non-initiating party for acceptance.

In addition to performing a scheduling task, preferred variations of the system 10 can be configured to store and create legal documents. Legal documents can be created in the system using database elements and technologies such as HTML, HTTP, .PHP, .ASP, MPLS, C, .VBS, C++, ASCII, PERL, XHTML, XSLT, XMLHTTPRequest, CSS, asynchronous JavaScript, Java, AWK, SED, XML, RSS (Really Simply Syndication) and document object model (DOM). The system inserts data from a case file and merges it with preformatted documents, i.e. notices of deposition, subpoenas, correspondence, etc. The system preferably stores original documents and other files in an uneditable format such as in Adobe® PDF file or image file to prevent users from altering the documents. Documents on the system can also contain a digital signature to ensure their authenticity.

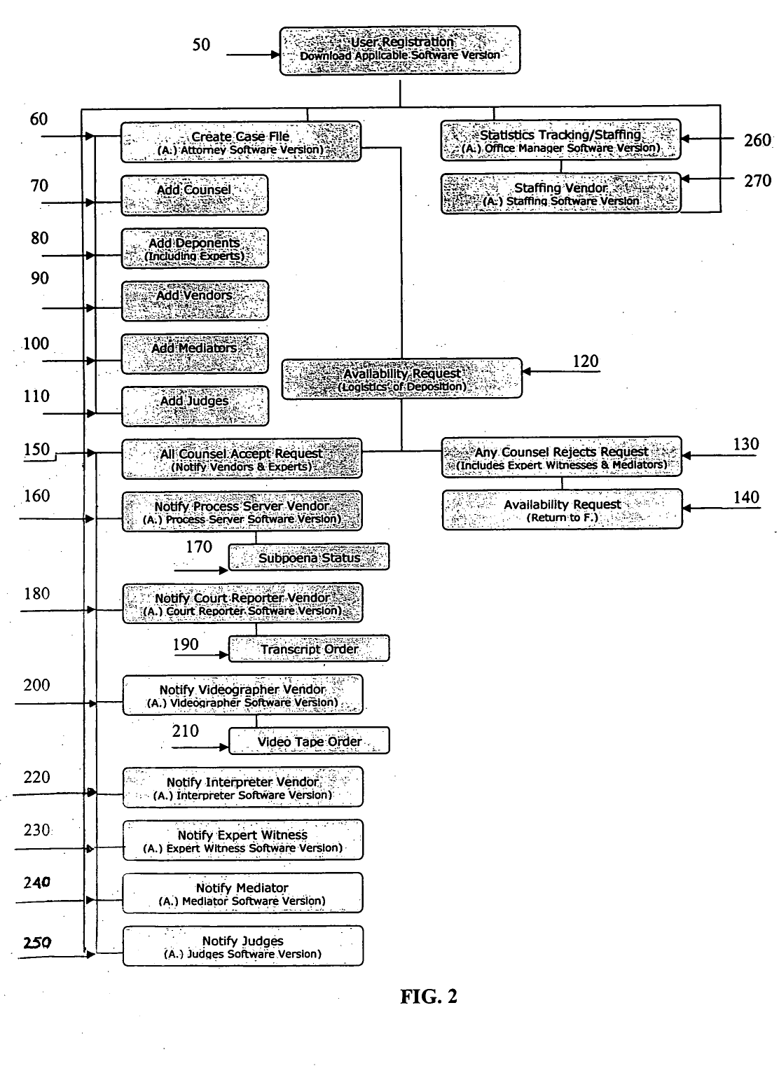

Referring now to FIG. 2, an exemplary method of scheduling a litigation event using the above-described system is shown. In step 50, a user (e.g., a lawyer/attorney, or assistant/secretary acting on behalf of the lawyer/attorney) accesses the home page of the software company over a computer communications network in order to obtain the software interface and to register an account with the service. Once the user has installed the software browser interface and registered an account, the user then clicks on an icon on the user's desktop operating system to launch the system interface, e.g., a program encoding a browser specifically configured for communicating with a server running the litigation even scheduling system. Upon the system browser opening, the user is brought to the system homepage so that the registered user can access the communications network and other parts of the system.

In the user registration process, users enter identification information that can include their full names, addresses, billing information, and bar number (if the user is an attorney, attorney representative, judge or judicial assistant). Bar number information can be confirmed by a staff member of the entity operating the system with the applicable state bar association or other agency to verify an attorney's or judge's identity and allow the user to use the system server for digital signatures (e.g., utilizing a system such as or similar to Adobe® Acrobat® LiveCycle Document Security) on electronic documents requiring an attorney signature such as subpoenas, deposition notices, motions, complaints, and answers to complaints. In addition, the identity of other users such as judges, mediators, vendors and expert witnesses can be confirmed utilizing simple registration techniques such as credit card verification before such users are allowed to utilize the service of the system.

In step 60, a new case file is entered into a database within the system by an attorney or attorney's assistant. Attorneys (and their assistants) can be provided versions of software used to access the system that allow creation of a new case file. The user can create as many case files as needed for the user's registered account. Data inputted for each new case file might include information identifying the litigation, such as a case caption and the law firm's internal file number (e.g., case number, matter number, client number) pertaining to the litigation or other in-house identification system. Additional information that can be inputted includes each plaintiff's name, each defendant's name,

the court's name, division and district, and the judge's name. Other data that might be inputted for each case file (if applicable) might be insurance company information such as the insurance company's name, the adjuster's name and contact information (e.g., address, phone number, fax number, and e-mail address), the claim number, the insured's name and contact information, the date and location of accident/loss, and the policy limits. Other data that might be inputted into the system can include any information useful for scheduling a litigation event including, for example, dates of service, names and contact information for registered agents, deadlines for filing documents (e.g., an answer), notice of and amount of extensions of time, date(s) for statute of limitations, assigned attorney names, introductory attorney names, name of individual creating the new file or new entry, and the date of file creation. The bulk of the data generally needs to be entered only once as it stays constant throughout the litigation.

In general, most of the data in each case file in the system is editable. In preferred variations of the system of the invention, however, some data is not editable, e.g., the date the case file is created in the database. Also, in preferred variations of the system of the invention, files are not deletable (although they can be indicated inactive). Electronic files (e.g., containing deposition notices, pleadings, deposition transcripts, hearing transcripts and/or trial transcripts) in the database portion of the system can be organized by (associated with) a particular case so that system users can easily find and access desired files. The system can be configured to allow case information and stored files to be imported, exported, and/or synchronized with other systems. And the system can also be configured to notify users via mobile electronic devices such as Blackberry™ devices, Windows mobile software, etc., of any changes or other updates made in a case including calendaring changes and updates.

In step 70 of FIG. 2, the system database includes a searchable directory of attorneys. A user entering a new case into the system can select the attorneys involved in the case from the directory (which would already include contact information and bar numbers of each listed attorney), or the user can enter this information into the system manually. Attorneys in the directory can be either a member (a registered user) or a non-member (a person not yet registered on the system) of the system.

In step 80 of FIG. 2, the user can add a list of potential witnesses, their contact information, and type of witness (expert or non-expert) to a case file in the system. This file is accessible only to the user who created it, as attorneys typically do not want the opposing counsel, for example, to know who they plan to take testimony of. Upon the user deciding which of the potential witnesses or deponents it plans to call for deposition, sworn statement, etc., the user can enter information and thus create a new case file that lists those witnesses and their contact information for that case file so that they can keep the witness or deponent listing in an organized and easily accessible manner and perform scheduling functions with other users of the system. The system can also have a directory of expert witnesses that is accessible to system users.

In step 90, a system user (usually an attorney) selects one or more vendors to provide services for the case or an event in the case. To facilitate vendor selection, the system can include a searchable database of vendors according to vendor name, service provided, and/or locations. The system can also include a means for a user to communicate with a vendor to request services for a particular case or event. The user can select system default vendors by searching the database of vendor members within the system. This database of vendors can include local (e.g., in-state vendors) as well as distant (e.g., out-of-state) vendors. To select a vendor not on the database (e.g., a vendor that is not yet a member of the system), the user can enter the non-member's name and contact information (e.g., e-mail or fax number) so that the system can communicate with the non-member via these methods. The identification of vendor selections by a user can be made available to other users of the system who are involved in the case or event.

In step 100, if applicable to a case, an attorney user can select a mediator (by the use of mediator is meant mediator, arbitrator, or like alternative dispute resolution professional) to mediate the case. To facilitate mediator selection, the system can include a searchable database of mediators according to name, experience, and/or location, fee schedule, and resume/vita, audio and video examples of the mediator. This database of mediators can include local (e.g., in-state vendors) as well as distant (e.g., out-of-state) mediators. To select a mediator not on the database (e.g., a mediator that is not yet a member of the system), the user can enter the non-member's name and contact information so that the system can communicate with the non-member. The system can communicate the identity of a suggested mediator for approval of other (e.g., opposing) attorneys involved in the case. Once a mediator is agreed on, the system can be used to coordinate the scheduling of an event with the mediator and other users.

In step 110, the user can select officials such as judges, magistrates, and commissioners that are designated to handle a case from a database of such officials contained in the system. The system can also include a means for a user to communicate with an official to schedule events such as hearings and trial dates. If the official is not listed as a member of the system, the user can enter the non-member's contact information so that the system can communicate with the non-member.

The litigation scheduling system also includes a calendar database which includes a file for each member that includes that member's calendar (i.e., calendar schedule). To facilitate this, the system can have the ability to synchronize with various types of calendaring software so that a user's file (i.e., calendar schedule) can be automatically updated when that user logs on to the system and can be prompted by the user to synchronize the system calendar with these other calendar systems. In addition, the system can display a RSS feed on the users desktop to inform the user of scheduling changes to the user's account. Thus, the user is not required to have the system browser open at all times. In step 120, a user desiring to schedule a litigation event submits to the system a request to schedule the event. The system then checks the calendar database files for each user who should attend the event to output to the requesting user a set of times and dates when all such users are available. The non-requesting users are not generally notified of the inquiry as this is simply a time and date availability check. The requesting user then can select one (or more) of the times/dates when all users who should attend the event are available and instruct the system to send notification of the scheduled event to the other users who should attend the event.

In step 130, when a user notified of a scheduled event cannot attend the event at the scheduled time (e.g., due to a conflict not on the user's calendar), the user can notify the scheduling user that they are not available, e.g., using the system to send an electronic message to the scheduling user. The user unable to attend the scheduled event can enter a response into the system such as (a) the user will send a substitute user to appear on his behalf, (b) the other parties may proceed with the scheduled event without requiring the unavailable user's attendance, or (c) the unavailable user requests that the event be rescheduled. In the case of (a), the response is stored on the system for the records of the unavailable user, but is not generally conveyed to the other users who should attend the event. In the case of (b) or (c), the response is generally reported to the other users who should attend the event. In step 140, in the event that the unavailable user requests that the event be rescheduled, the requesting user reschedules the event by again beginning the process at step 120. These steps are repeated as necessary.

Steps 120-140 are preferably performed only for non-vendor users (e.g., attorneys, expert witnesses, mediators and judges). Once an event is scheduled among non-vendor users, the system, in step 150, contacts (e.g., via data exchange, e-mail, or fax) vendor users and asks them to confirm acceptance of the scheduled date and time for the event. If the user is a member of the system, the user can be notified through the system, e.g., via a system message board which displays the electronic data transmitted. When new events appear on a main message board, there can also be an accompanying sound or audible indicator as well as a visual cue. The user can select a checkbox or click an appropriate button or hyperlink next to each new scheduled event to accept the scheduled event, to not accept the event, or to request that the event be rescheduled. The response is conveyed back to the requesting user.

For example, once the scheduled event date and time are confirmed, if applicable, the requesting user can use the system to notify a process server vendor (step 160), a court reporter vendor (step 180), a videographer vendor (step 200), an interpreter vendor (step 220), and/or other vendors. Each of the vendors can be provided with software for accessing the litigation scheduling system over a computer communications network. The software can be specifically configured for each vendor type so that each has convenient access to information useful for that particular vendor type but not other information on the system.

For instance, in step 170, system-access software configured for use by a process service vendor can allow a process server user to update the status of a subpoena service by accessing the system over a personal computer or via a wireless device able to communicate with the system. Other system users can then access the status of the subpoena service by accessing and querying the system. As another example, in step 190, system-access software configured for use by a court reporter can allow a court reporter to upload transcripts of a litigation event so that they can be accessed, ordered (e.g., hardcopy to be sent by mail or courier), and/or downloaded by other system users. Similarly, in step 210, system-access software configured for use by a videographer can allow a videographer to upload videos of a litigation event so that they can be accessed, ordered, and/or downloaded by other system users. Software for vendor users might also have other functions such as calendaring and invoicing. In some embodiments, the system might be configured to inform users which users have accessed and/or downloaded files from the system.

In step 230 of FIG. 2, system-access software configured for use by expert witnesses allows expert witnesses who are deposed on a continuous basis to have their calendars integrated into the database. The system can check with these witnesses' calendars and incorporate them into the scheduling process. This also allows this type of witness to request a reschedule or cancellation of their deposition based on emergency purposes and provides the ability to notify all attorney users immediately without expending time attempting to get the information to the correct parties via traditional methods. The expert witness can also submit electronic records or documents directly to other users via the system. The system can also include an invoicing feature.

Once a time and date is agreed on by all users who should attend a litigation event, the system can send all attending users data containing the logistics of the event (e.g., date, time, location, directions). At this point, an attorney's assistant utilizing the systems features can merge the event and case information into database-integrated documents including but not limited to subpoenas and notices of deposition, etc. This information can be inserted into the documents via XML or other methods and can include, for example, the full case caption, county, state, circuit or county court, division, case number, witness name, date, time, and location, etc. Such information is available when the case information is entered into the database when the case file is first created. Once this information is entered into the documents, each document is signed by the attorney with an authentic digital signature and sent to each respective vendor as well as all counsel involved, expert witnesses, mediators and judges. Once this document is digitally signed, the original is preferably not alterable by the receiving parties. The final document can be in Adobe® Acrobat® or another file type to ensure the integrity of the document.

In step 240 of FIG. 2, a system-access software configured for use by mediators allows attorneys to notify mediators as to the logistics of mediations, for example. In step 250 of FIG. 2, system-access software configured for use by judges or other hearing officers allows the judges, officers, and/or their assistants to notify attorneys as to the logistics of hearings and trials, for example. The system can also include a document transferring function as well as an invoice function.

In step 260 of FIG. 2, a system-access software configured for use by an office manager (or other office administrator) provides an office manager the ability to track statistics of the system within the law firm. The statistics tracked include but are not limited to the number of accounts, cases, witnesses, users, time used on the system, number of events scheduled, number of reschedules, number of cancellations, number of confirmations, number of vendors notified, number of electronic documents delivered (e.g., subpoenas and deposition notices), and comparative results for the entire organization for a day, week, month, year or years. The system also tracks the number of deposition orders, the time of the orders, and the total costs of such orders. It also comparatively analyzes the total savings for the firm based upon usage derived from predetermined methods of analyzing the time it takes to accomplish similar tasks using traditional methods of scheduling depositions. This demonstrates to the office manager how efficient the system is and how much time per person using the system that the firm saves in overhead waste. In step 270 of FIG. 2, the office manager version also connects to the database via the graphical user interface to provide the opportunity for law firms to inform staffing companies of orders for personnel. The office manager can select which qualifications the staffing company must provide for the current open position.

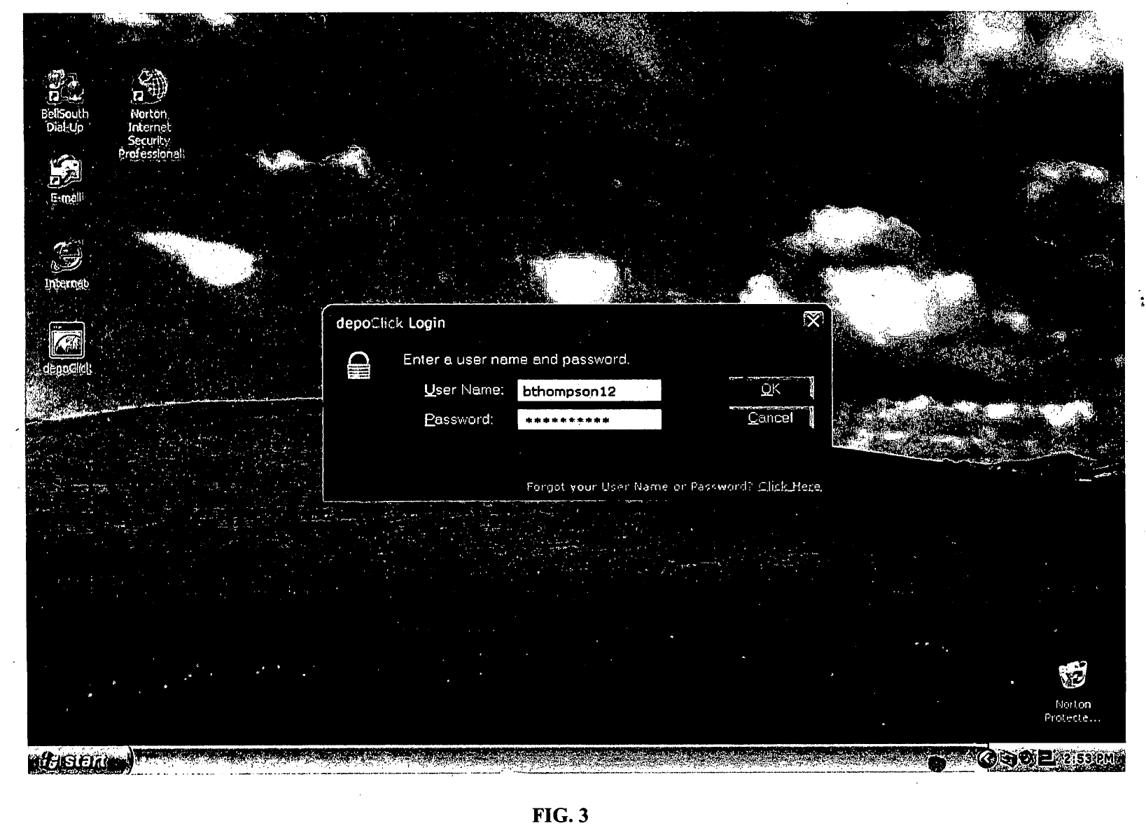

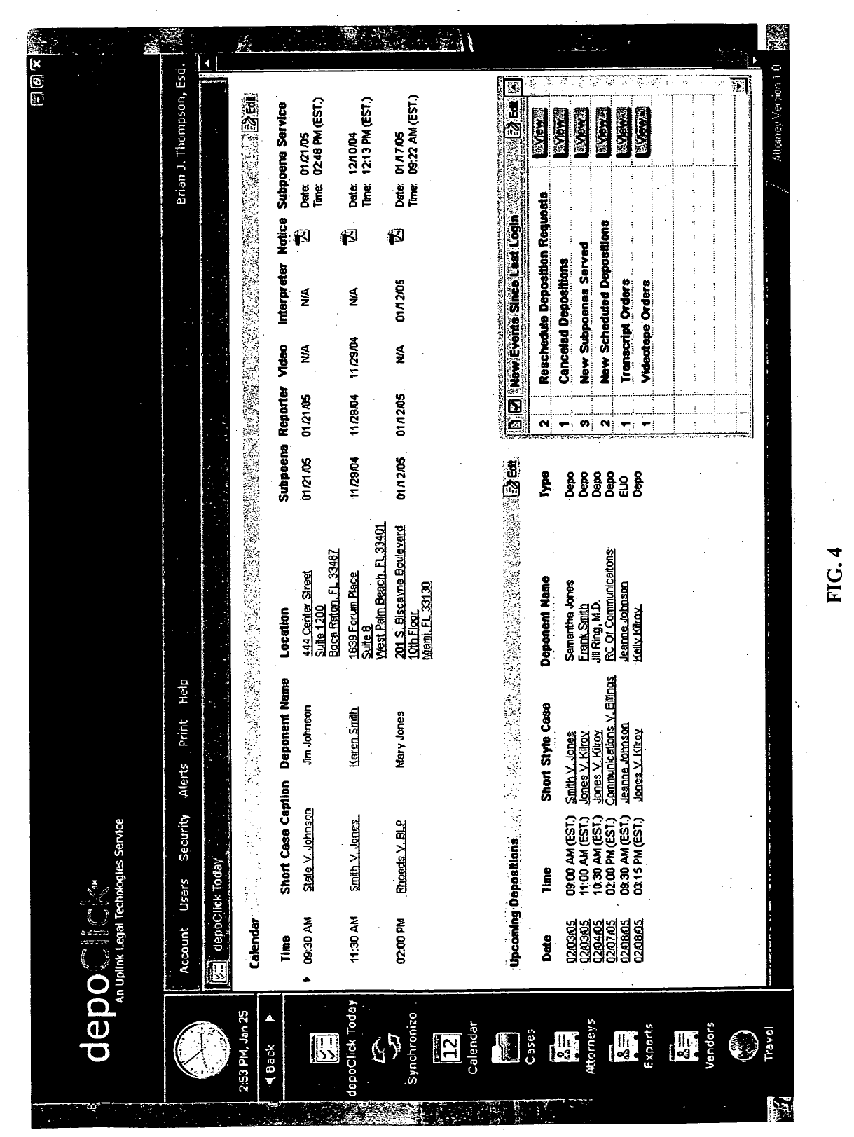

Referring now to FIGS. 3-24, an example of one aspect of the system is illustrated in a series of screenshots. These screenshots illustrate a series of pages of the litigation event scheduling system that a user accesses, beginning with the system log-in screen (FIG. 3). To gain access to the system, the user downloads the appropriate software from an entity operating the system. The user then installs the software onto the user's computer which, upon completion, displays an icon on the user's desktop computer screen. After installing the software, the user registers and creates an account to allow the browser to access the communications network. If registration is successful, the user is able to access the system home page (FIG. 4) by utilization of the browser. To access the system home page, the user clicks the desktop icon indicating launch of the system browser. The URL and home page are preset within the system browser. Once the desktop icon is clicked by the user, the login screen (FIG. 3) appears, prompting the user to enter a username and password obtained during registration. When the user obtains validation from the server as to the authority and validity of the user and the software opens, the user is transported to the system “Home” or default URL page (FIG. 4).

The system home page (FIG. 4), as well as all other pages of the system, contains a number of data elements (i.e., elements of data displayed to the user on the screen) and functions with corresponding buttons (i.e., hyperlinks or icons allowing the data to be displayed differently or requesting the data to be queried by the system server in some way so as to manipulate it). Elements and functions featured on the home page and subsequently accessed system pages include, for example, time and date display, account name display, account button, users button, security button, print button, save button, alerts button, help button, Home button, synchronize button, calendar button, case or file button, attorneys button, experts button, insurance button, mediators button, vendors button, travel button, map button, Adobe® PDF button, notice button, document button, view button, edit button, case hyperlinks to access the corresponding case file, witness hyperlinks to access corresponding witness or deponent files and advertisement displays. In FIG. 4, several of these elements/functions are shown in the upper portion of the screen shot (e.g., account, users, security, alerts, print, help) as well as grouped together along the left side of the screen shot under the heading “My Shortcuts” (e.g., synchronize, calendar, cases, attorneys, experts, vendors, travel). Other pages of the system feature these elements as well as additional elements or functions that pertain to particular tasks or users. When the user clicks on buttons (e.g., hyperlinks, icons) on the home page and any subsequent pages, instructions are sent to the server to perform various functions or tasks and results are returned to the user by displaying of the data on the graphical user interface.

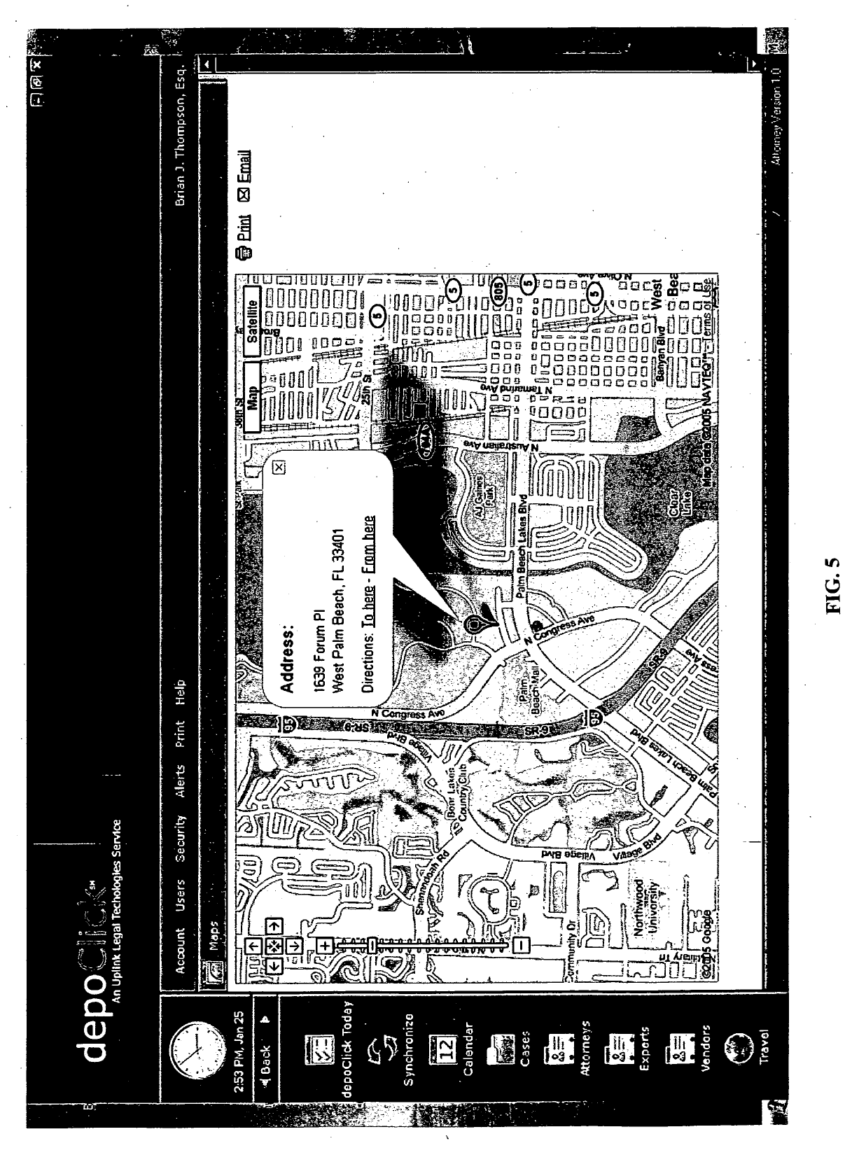

The home page is configured to give an overview of the day's activities. This page can also contain a section labeled Calendar. This section displays data regarding the current day's scheduled events or activities. The home page displays certain data and features such as, for example, the current day's depositions, hearings, trials, mediations, examinations under oath, sworn statements, meetings (e.g., council meetings, homeowners association meetings, board meetings, etc.), Independent Medical Examinations (IME) and subpoena duces tecum activities which include time of event, case caption, deponent or witness name, mediator name, examining physician name, and type of duces tecum records. The home page also preferably features a map and driving directions function integrated into the browser that provides the user with assistance in locating the litigation event. By clicking on the MAP button or hyperlink pertaining to a particular litigation event of interest on the home page (or other page of the system), the user is brought to a page (FIG. 5) that shows a map of the area surrounding the litigation event location as well as the option to obtain directions to the location.

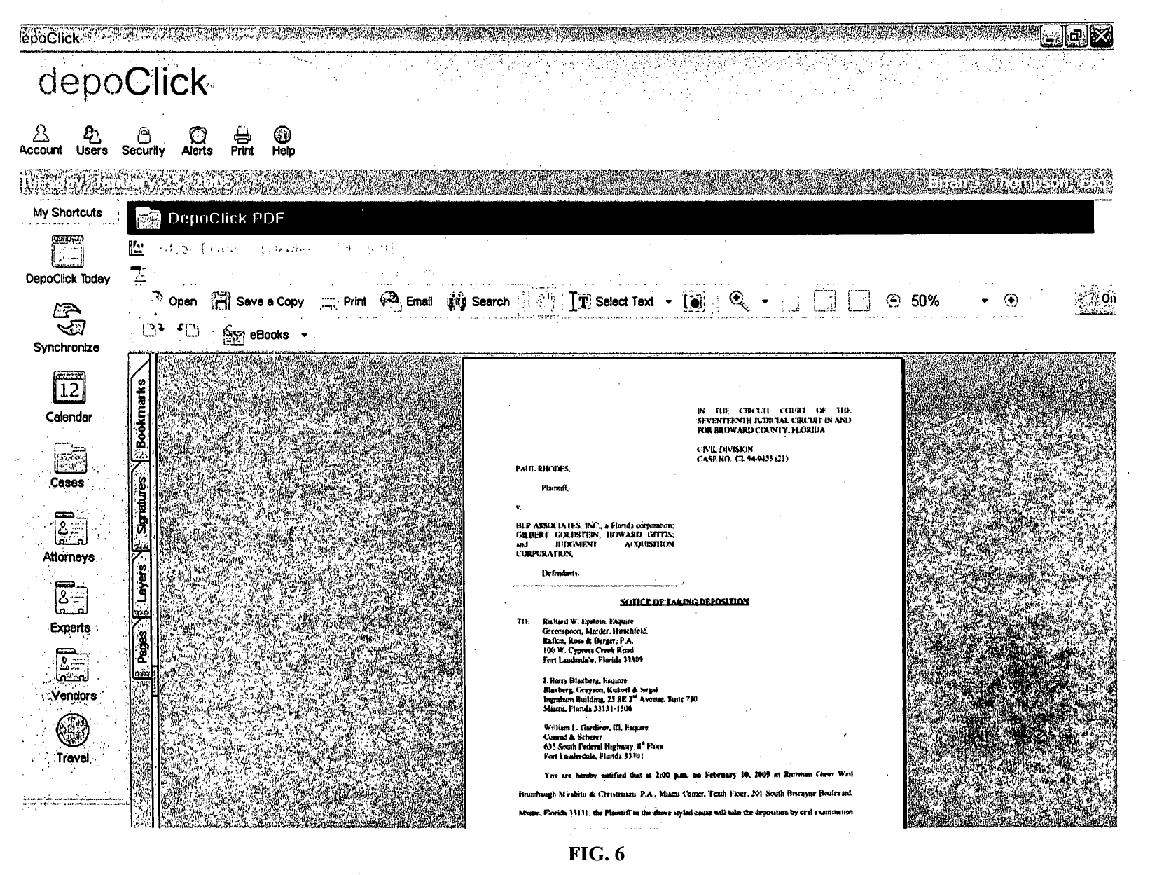

The system home page (FIG. 4) features current status indicators that include, for example, subpoena or process service of the deponent, expert witness notification, examining physician notification, court reporter notification, videographer notification and interpreter notification. The user can edit what is displayed in this area depending upon the user's needs. For example, if the user only wants to display the date, time, location and the corresponding PDF notice, the user can click on a button to customize the layout of the screen to these preferences. From the home page, the user is able to access an electronic document of a notice of the deposition corresponding to a particular case in Adobe® PDF format or similar type of document by clicking on the corresponding icon (e.g., PDF icon) or hyperlink as shown in FIG. 6. The ability to access such electronic documents is a function that is integrated into the browser. The home page may also contain a section labeled Upcoming Depositions or Upcoming Events. This section displays a listing of the upcoming activities or events by displaying the same data elements as described above. The home page may also contain a section labeled New Events Since Last Login (or similarly labeled). This section displays changes from other members of the network that affect the user's account and to which the user will need to address. This list contains a corresponding number next to each event (e.g., rescheduled requests, canceled requests, new subpoenas served, new scheduled items, transcript orders and videotape orders) that indicates the number of new tasks that require input from the user. These tasks indicate changes to events that are listed in this section. The events listed can also indicate text messages from other members. For example, the attorney that has requested a rescheduling of an event can input a text message to give a short explanation for the rescheduling request.

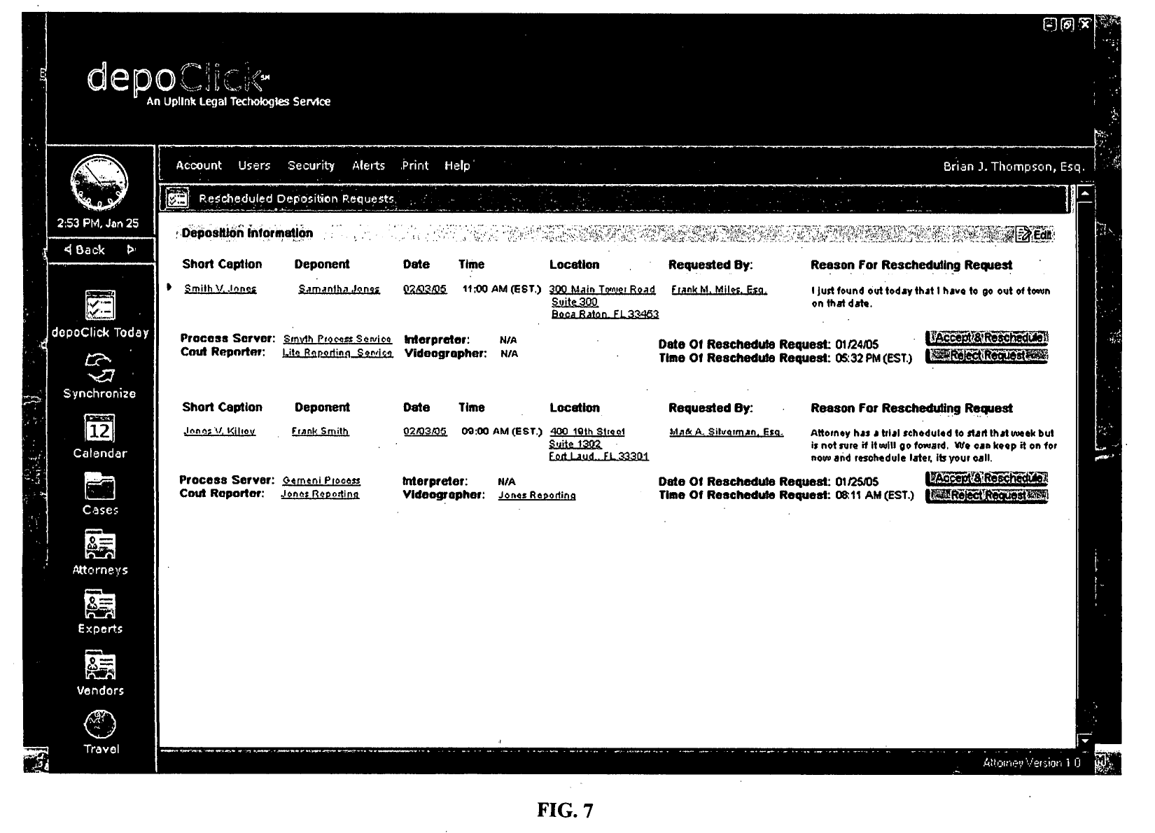

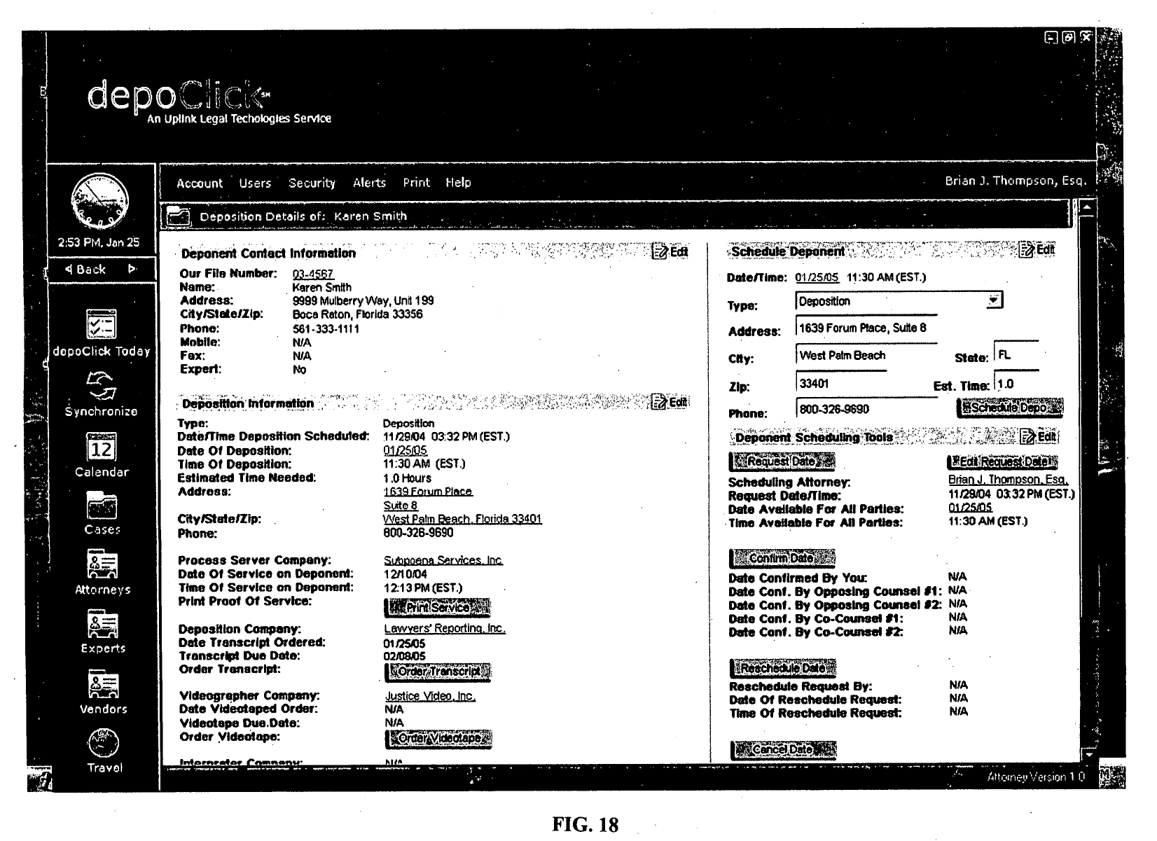

The home page features a button (e.g., hyperlink, icon) that sends the user to the Reschedule Deposition Requests page (FIG. 7) which shows other members' requests for a rescheduling of one of the previously mentioned services that has already been scheduled. The information for this event includes the current logistics for the scheduled event. The page also displays the name of the member or account name of the person requesting the rescheduling, the date and time of the request with a corresponding time zone indicator, a button or hyperlink to accept the requested logistics and a button or hyperlink to reject the requested logistics. If the user clicks the accept and reschedule button or hyperlink, a corresponding confirmation of the action is sent to the database server and to the respective parties (i.e., users) on the case. The user is then transported to the Deposition Details Of: (Deponent Name) page (FIG. 18) to perform the tasks necessary to reschedule the event or service. In some embodiments, this screen may have a reject request button, which when clicked by the user, delivers the data to the other users via the database and there are no changes to the deponent or witness' scheduled event. This page also contains data displayed as hyperlinks allowing the user to view more detailed data by clicking on the hyperlink. As with all subsequently accessed pages, the user can edit the information displayed on this page to his preferences.

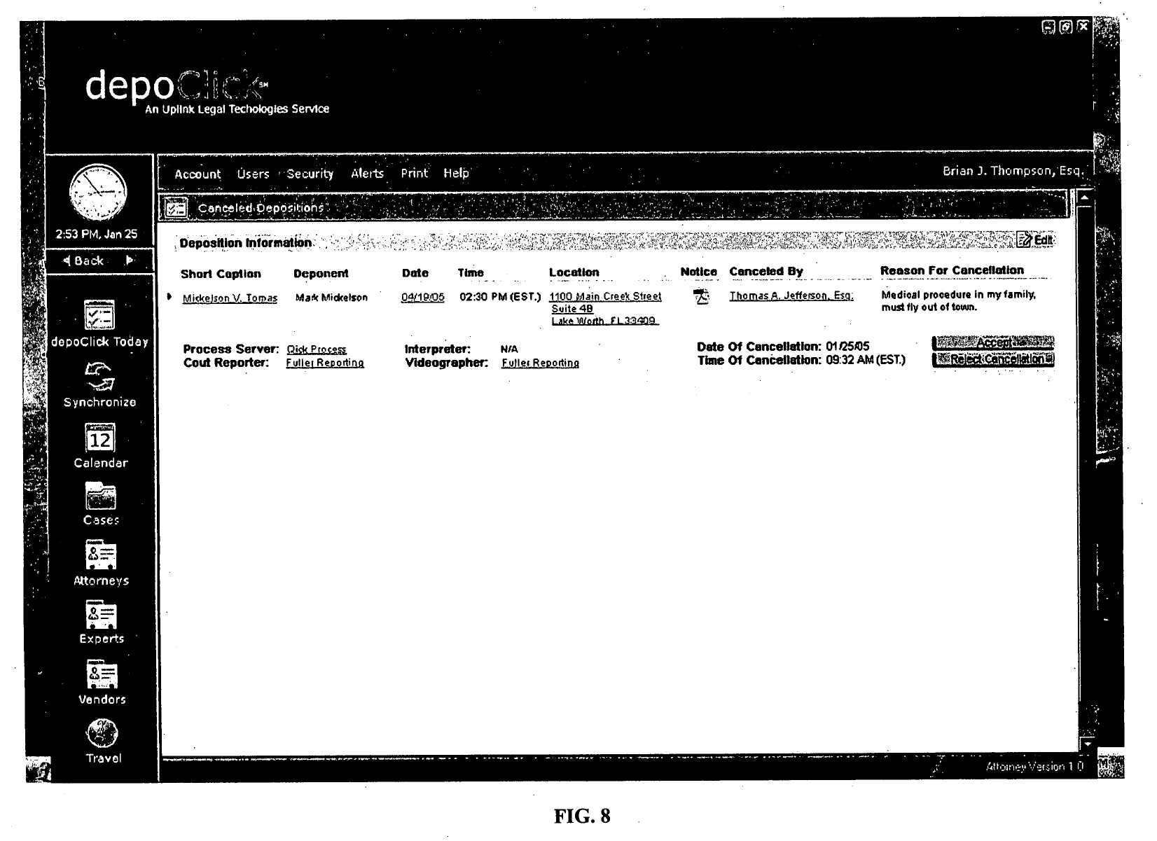

The home page also features a button or hyperlink for sending the user to the Canceled Depositions page (FIG. 8) which shows other members' cancellations of previous services for a particular litigation event that have already been scheduled. The information for this event includes the previous logistics for the scheduled event. The page also displays the name of the person canceling the event, the date and time of the request with a corresponding time zone indicator, a button or hyperlink to accept the cancellation and a button or hyperlink to reject the cancellation. The page also contains data elements such as the case caption, deponent or witness name, date and time of the event with corresponding time zone indicator, location of the event including the full address, PDF or electronic documentation regarding this event or service and a text display from the user requesting the cancellation which displays the reason given for the request. The page also displays data elements regarding the vendors for the scheduled event. This page may also display data as hyperlinks, e.g., names of vendors, which upon clicking will allow the user to view the vendor's profile, and date of the event, allowing the user to view that date on the calendar feature when that hyperlink is clicked. If the user rejects the cancellation they are brought to a page where they can schedule this same event (explained in the scheduling feature below). This is similar to an attorney cross-noticing a deposition, allowing the user to keep the same event on by scheduling it themselves.

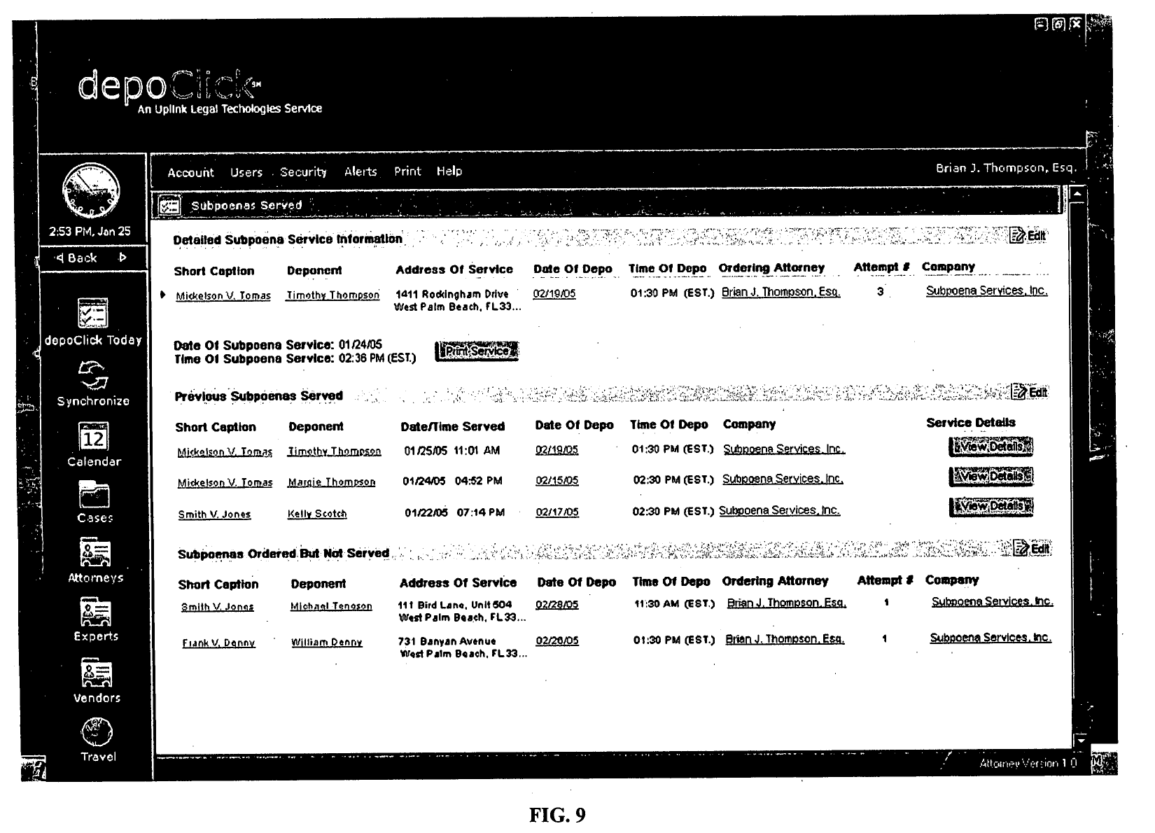

The Subpoenas Served page (FIG. 9) shows subpoenas served and subpoenas ordered but not yet served upon witnesses or deponents by the user's designated process server(s). To connect to the Subpoenas Served page, the user clicks the corresponding button or hyperlink on the home page to connect to this page. This page may contain a section labeled Detailed Subpoena Service Information. Information provided in this section includes, for example, the case caption, deponent or witness name, address of service, date and time of event or service with corresponding time zone indicator, ordering attorney, number of attempts of the service, who was served, the date of the subpoena service, time of the subpoena service with a corresponding time zone indicator and the process server company name and any other data necessary to perform the service. This section may also contain a button or hyperlink allowing the user to view and/or print the proof of service which is an electronic document created by integrating database elements of the subpoena details by using XML or other suitable technologies. Such a document is initially created by an attorney user and sent to the process server user electronically. It is then manipulated by a process server user and transmitted back to the attorney(s) to indicate that service for a subpoena has or has not taken place as ordered. This electronic document may be an Adobe® PDF document or similar document that may also contain a digital signature or other form of authentication for such electronic documents. This page may also contain a section labeled Previous Subpoenas Served. This section displays a listing of the most recently served subpoenas which may display the same data elements as described above including buttons or hyperlinks allowing the user to view the details of the subpoena service and display these data results in the Detailed Subpoena Service Information section described above.

While on the Subpoenas Served page, the user can click on a button or hyperlink pertaining to a particular recently served subpoena listed in the Previous Subpoenas Served section to view details of the recently served subpoena. The Subpoenas Served page may also contain a section labeled Subpoenas Ordered But Not Served which displays the data elements of subpoenas ordered by the user but not yet served on the deponent or witness at the present time. These are considered unfulfilled services at the present time. The user can click on a button or hyperlink pertaining to a particular subpoena not yet served and view more detailed information pertaining to that subpoena by clicking on the hyperlink.

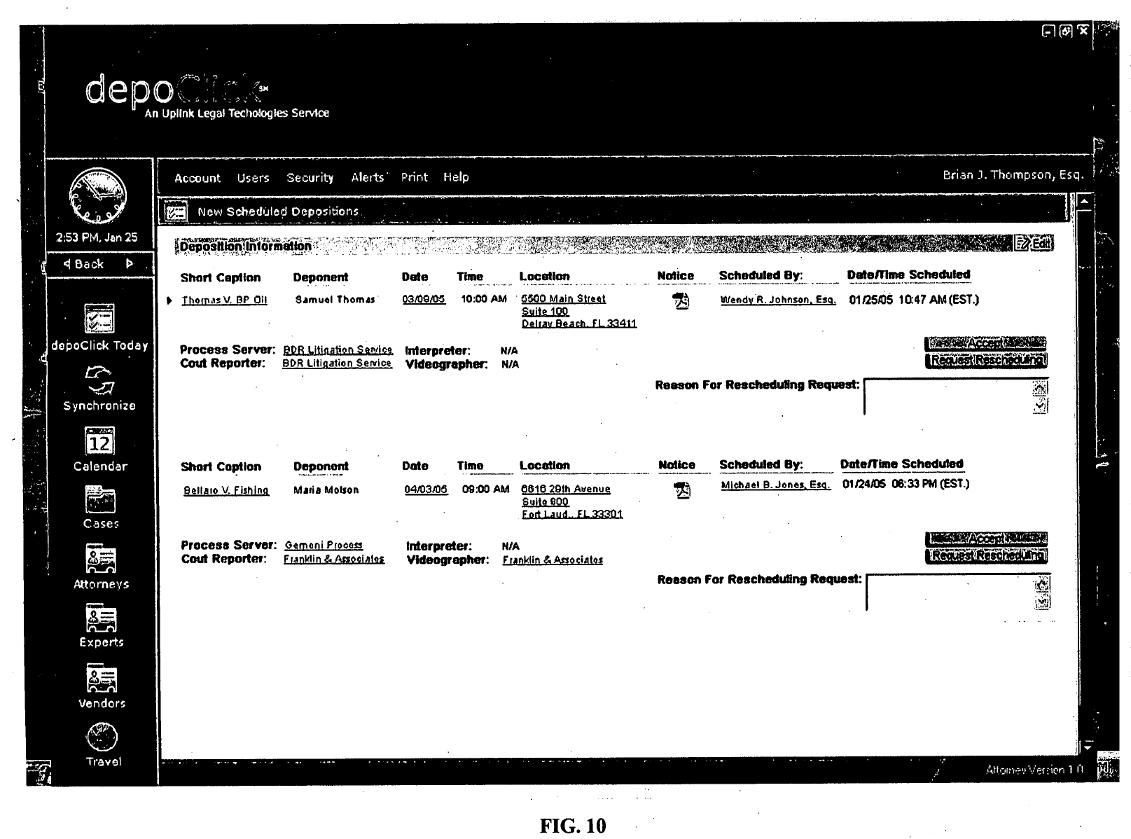

From the home page, the user can be sent to the New Scheduled Depositions page (FIG. 10) by clicking on the corresponding button or hyperlink. This page shows the scheduling of events of other individuals attending the event via the database reflected as changes to the user's account based upon the systems analysis of calendar availability and member's relationship to the event. This page displays the logistics for the scheduled event including any vendors necessary to complete the service that has been ordered from the scheduling party. These data elements may be hyperlinks by which the user can view other information such as a vendor's profile. The page displays data elements such as, for example, case caption, deponent or witness name, date and time of the event or service with a corresponding time zone indicator, address or location of the event with corresponding map and driving directions function (FIG. 5), PDF or electronic documentation for the event, vendors information for this event or service, name of the member or account name of the person scheduling the event or service, the date and time of the request with a corresponding time zone indicator, and a button or hyperlink to accept the schedule and a button or hyperlink to request a rescheduling of the event and a text message box for the user that is requesting the rescheduler to enter a text message explaining the reason for the rescheduling request. Again, these buttons or hyperlinks transmit instructions to the server to complete tasks or functions.

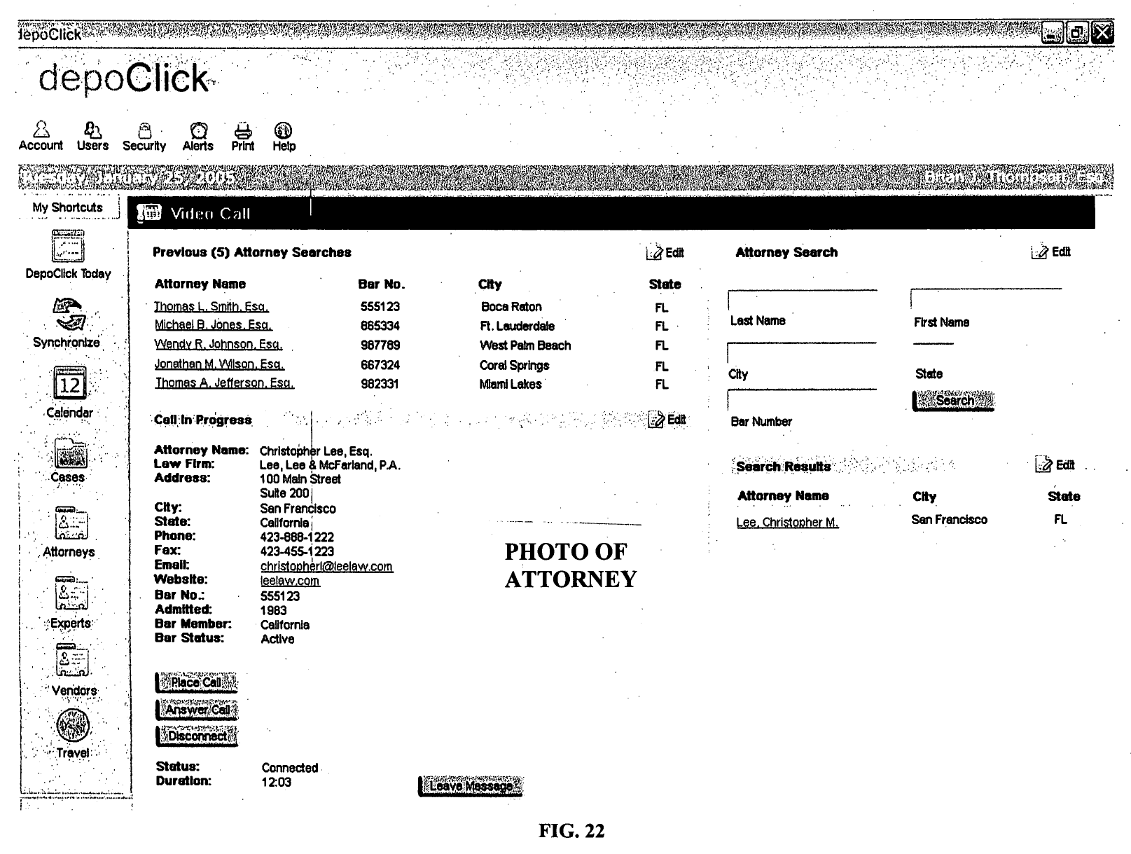

The system also provides a videoconferencing feature for two or more users. This feature allows attorneys, for example, to communicate via videoconferencing to discuss matters such as a possible settlement of case, as well as allowing attorneys and mediators to conduct a virtual mediation. The video call feature also allows attorneys to appear via videoconferencing at hearings before judges. The Video Call page (FIG. 22) contains functions relating to and facilitating a video call between two or more users (e.g., two or more attorneys).

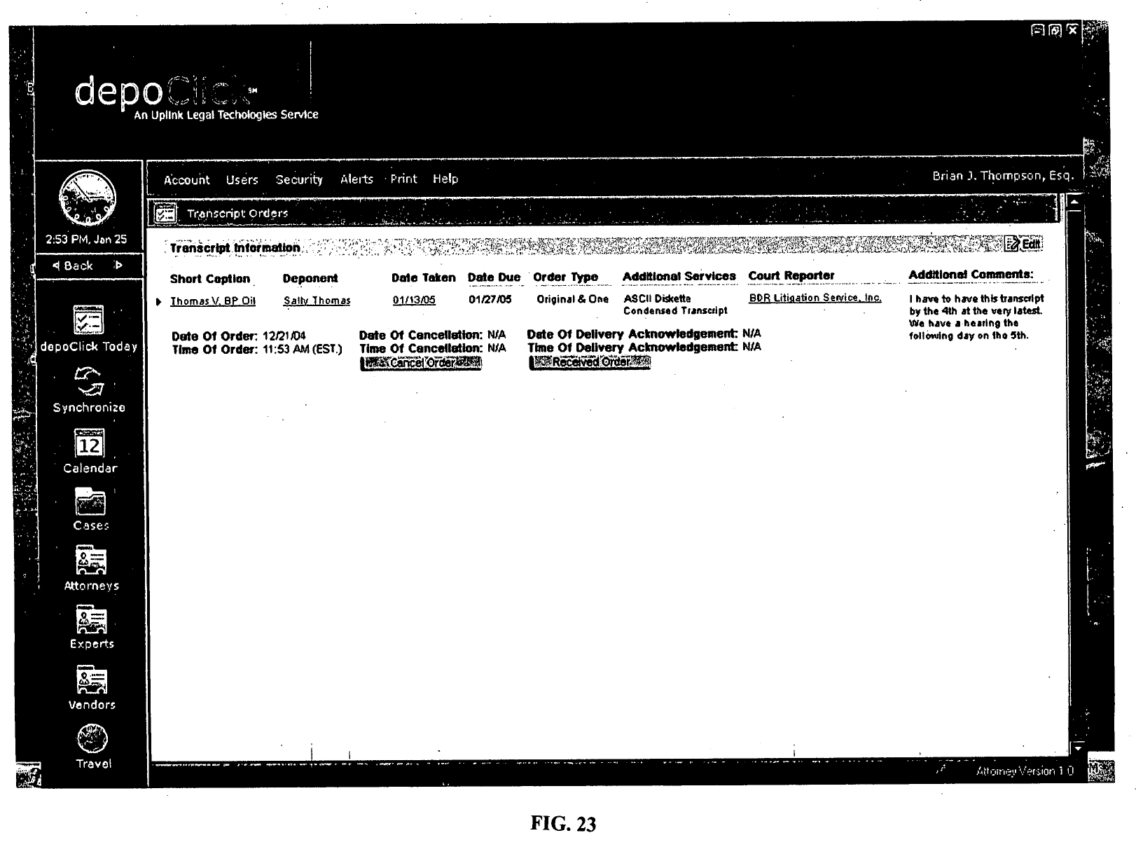

From the home page (FIG. 4), the user can be sent to the Transcript Orders page (FIG. 23) by clicking the appropriate button or hyperlink. This page contains functions relating to transcripts ordered by the attorney and delivered to the attorney from the court reporting company. Such functions include, for example, case caption, deponent name, date of event, transcript order date, transcript order time, type of order, additional services ordered, expected transcript delivery date, order cancellation button with order cancel date, order cancel time, transcript delivery acknowledgement button with delivery acknowledgement date, and delivery acknowledgement time.

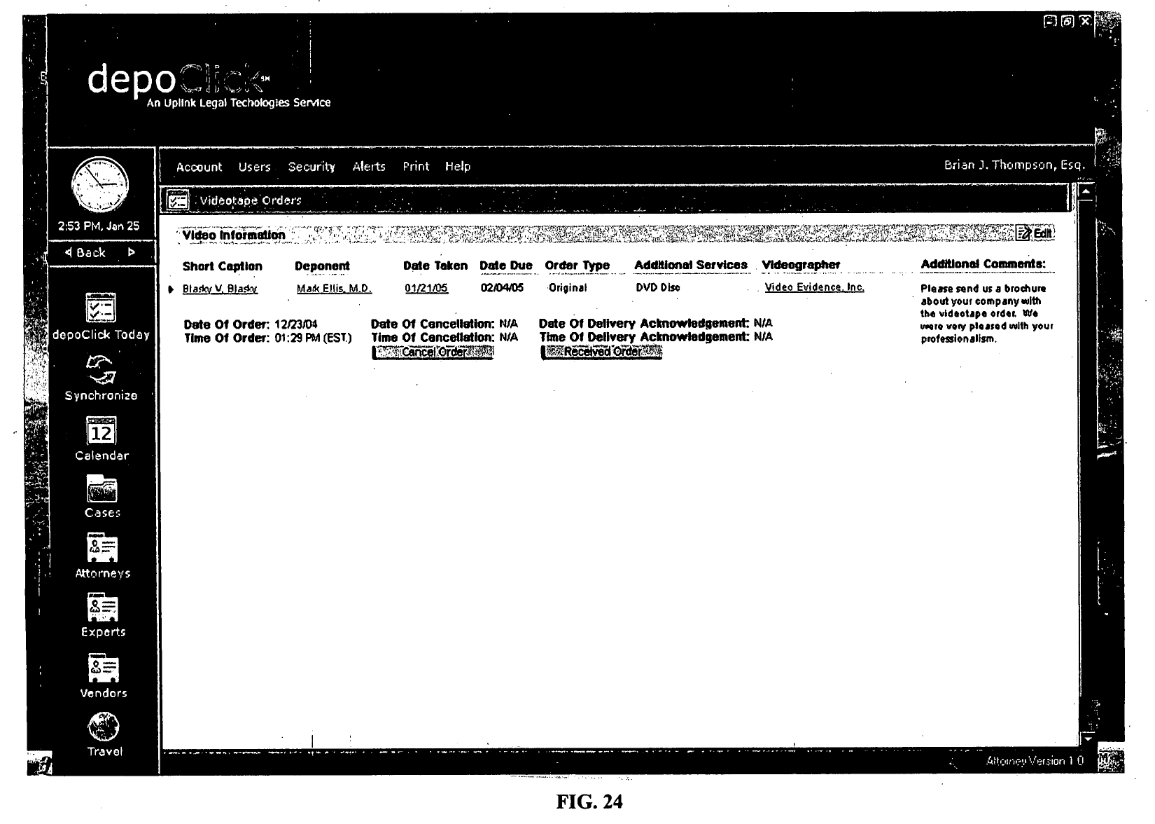

A user can access the Videotape Orders page (FIG. 24) by clicking on the corresponding button on the home page. The Videotape Orders page contains functions pertaining to videotapes ordered by the attorney and delivered to the attorney from a video company. Such functions include, for example, case caption, deponent name, date of event, videotape order date, videotape order time, type of order, additional services ordered, expected videotape delivery date, order cancellation button with order cancel date, order cancel time, videotape delivery acknowledgement button with delivery acknowledgement date, and delivery acknowledgement time.

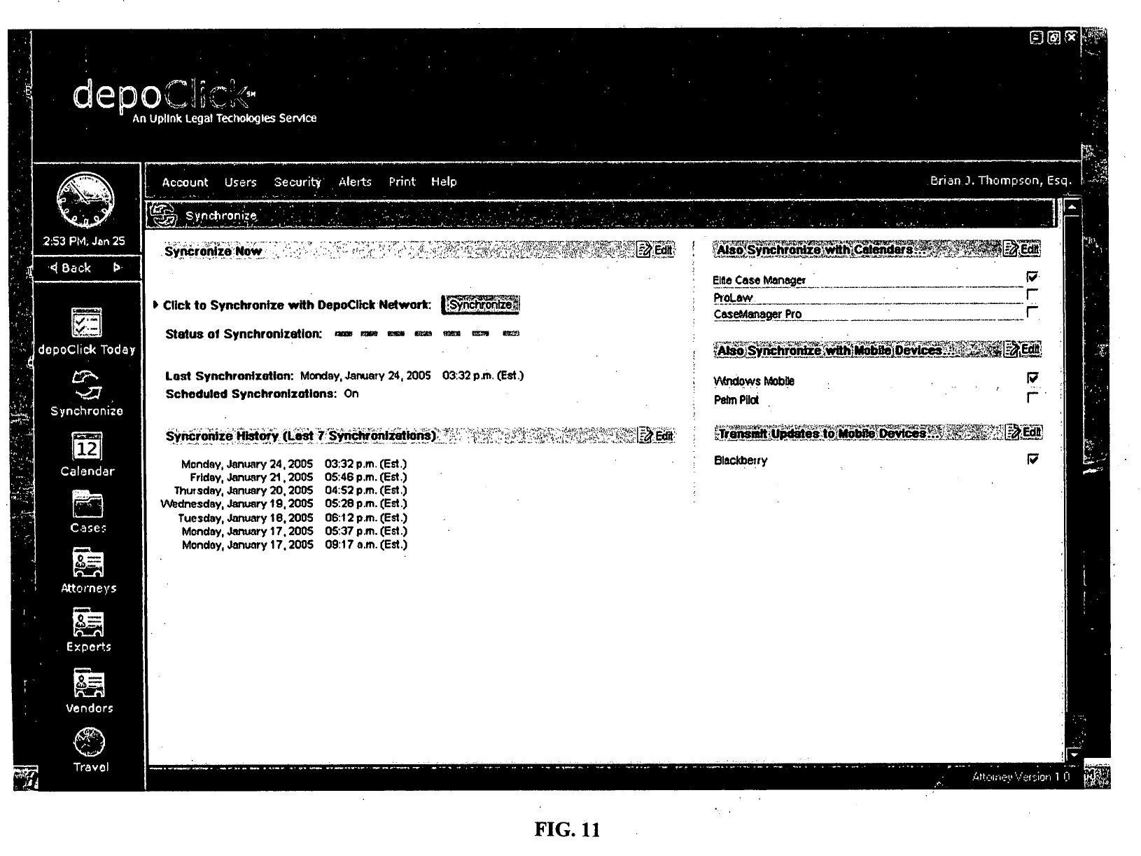

By pressing the Synchronize icon (found on the left side of nearly all of the pages of the system), a user can access the Synchronize page of FIG. 11 which shows the ability of the user to update his calendar and scheduling functions by synchronizing the user's computer with the system server. The page also synchronizes with the user's calendaring software, mobile devices including Windows mobile software and Blackberry™ devices. The Synchronize page displays information such as status of the synchronization, last synchronization date and time, a listing of history of the previous dates and times of synchronizations, status of predetermined automatic synchronizations, synchronization preferences with other calendaring programs, synchronization preferences with mobile devices and synchronization preference with Blackberry™ devices. The page also contains a button or hyperlink allowing the user to activate the synchronization process and also allows the user to edit the choices of preferences and the information displayed on this page.

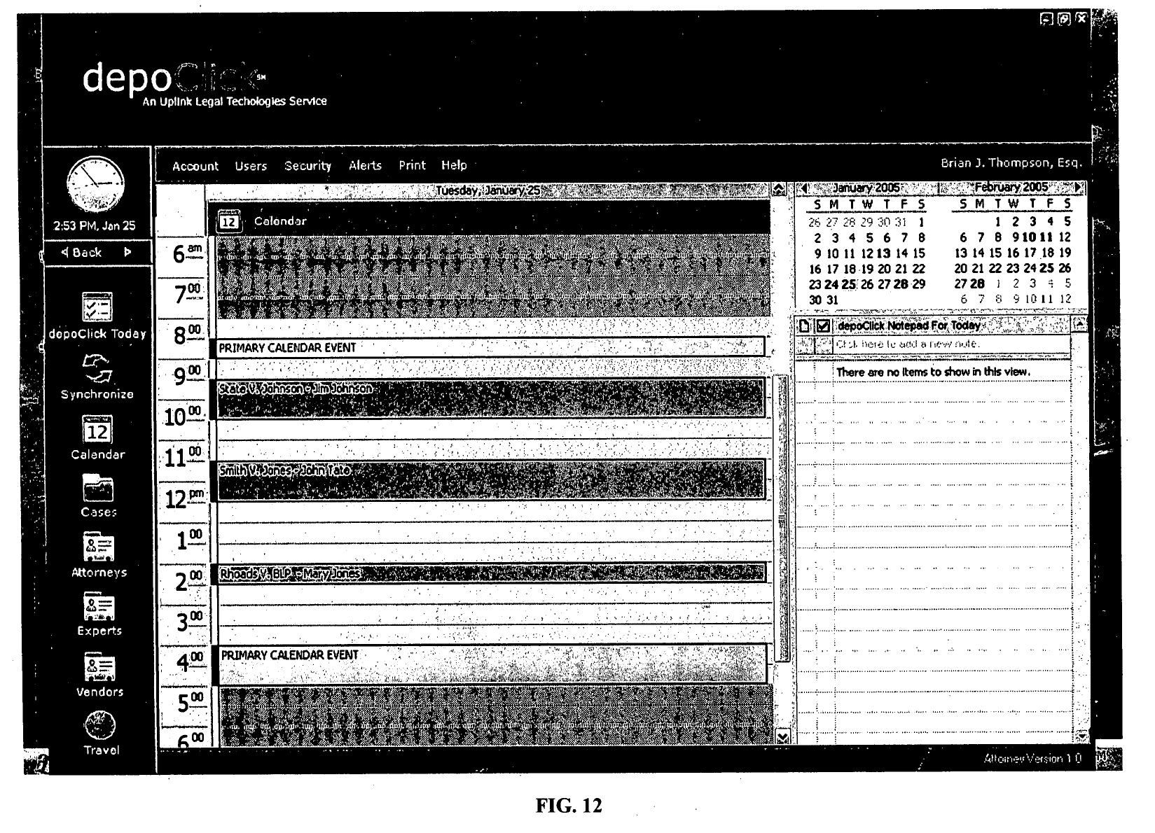

From nearly any page of the system, a user can access the Calendar page (FIG. 12) by clicking on the Calendar icon found on the left side of the page. The Calendar page allows the user to view all events on a familiar calendar layout. The Calendar page displays basic calendaring features found on most calendaring software programs. Events scheduled for the user appear on the corresponding dates and times with event information including case caption, witness name, location of event, and length of event, etc. The page also allows for reminders of events based upon the user's preferences. The page also displays a daily, weekly, monthly and yearly calendar view. The user can select any date on the calendar by clicking on the date which will reveal the daily calendar view and display events scheduled for that day. This calendar page is the same calendar that contains listings for all scheduled events with corresponding dates and times and is coordinated with the calendars of other individuals attending the event by synchronization with the system server. The page also displays an electronic notepad so that the user can make specific and personal notes regarding that selected day's events.

A Mediator page is also included in the system. This page displays the profile information pertaining to other users classified as mediators. This page serves as an electronic contact database whereby the user can search for other users and view those users' profiles. The page displays search functions whereby the user can search for a mediator by certain parameters including, for example, first name, last name, city, state and area of expertise. When the user searches the database, the interface sends a query to the server and displays the results based upon the parameters. The names of mediators found in the query are displayed as hyperlinks. The user can select a name by clicking on the hyperlink and thus displaying the detailed profile of that mediator. This detailed profile contains information such as, for example, first name, last name, company name, address, city, state, zip code, phone numbers, fax numbers, e-mail address as a hyperlink, company Web site address as a hyperlink, primary area of expertise, education, licenses, detailed profile of areas of expertise, a PDF or similar downloadable document of vita or resume, fee schedules and a photograph of the member as well as audio and video samples of the mediator speaking. The hyperlinks for the mediator's profile pertaining to e-mail and Web sites allow the user to click on the hyperlinks resulting in the user's default Web browser or default e-mail program performing the indicated function.

Another page included within the system is an Insurance Company page. This page serves as an electronic contact database whereby the user can search for insurance companies, adjusters and other claims representatives. The user can deliver electronic files (e.g., invoices, documents) directly or forward electronic invoices from vendors to the applicable insurance adjuster. The user clicks the corresponding button from the main function list to connect to this page which displays the information. The Insurance Company page displays search functions whereby the user can search by certain parameters including, for example, company name, adjuster name, city and state. When the user searches the database, the interface sends a query to the server and displays the results based upon the parameters. The resulting names are displayed as hyperlinks. The user can select a name by clicking on the hyperlink and thus display the detailed profile of the insurance company, adjuster, or claim representative. This detailed profile contains information including, for example, company name, adjuster name, address, city, state, zip code, phone numbers, fax numbers, e-mail address as a hyperlink, company Web site address as a hyperlink, company logo artwork or photograph and year established. The hyperlinks for the insurance company's, adjuster's, or claim representative's profile pertaining to e-mail and Web sites allow a user to click on them resulting in the user's default web browser or default e-mail program performing the indicated function. The page also lists results from a number of previous searches.

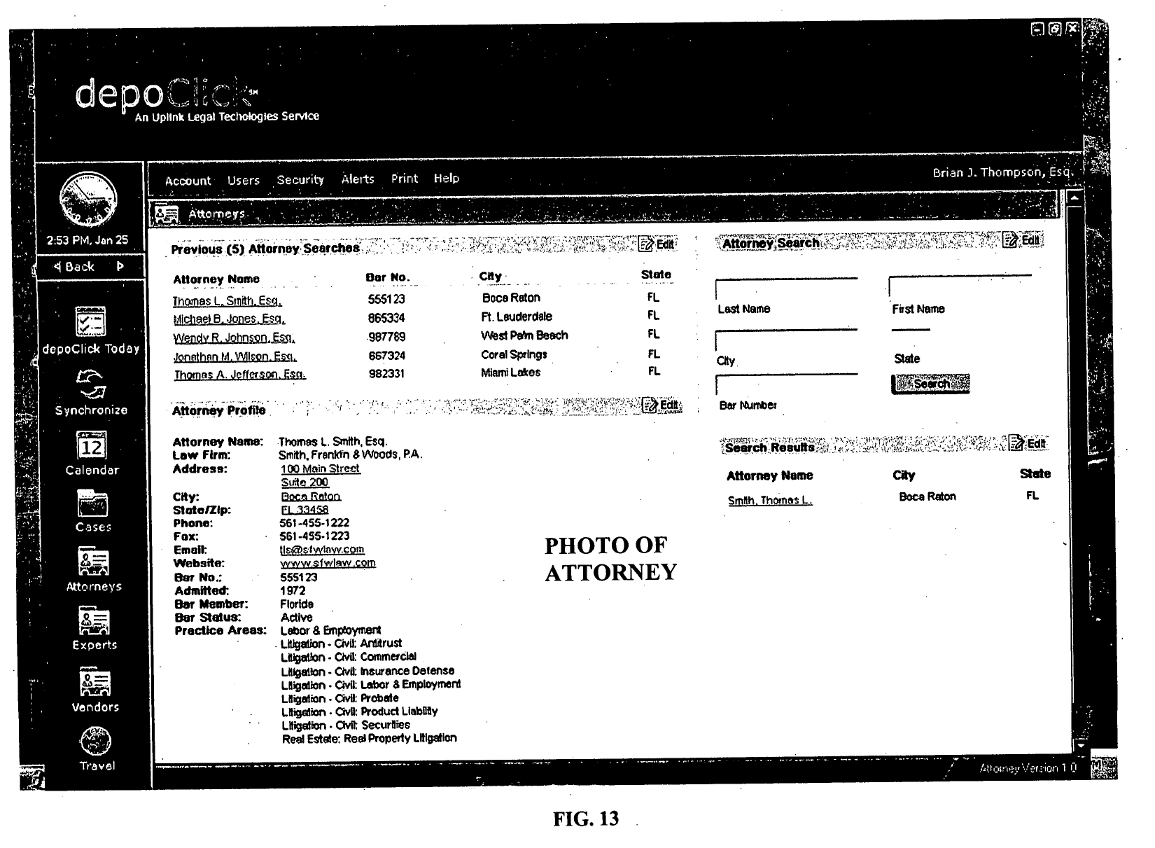

By clicking on the Attorneys button found on the left side of nearly any page of the system, the user is sent to the Attorneys page of FIG. 13. This page displays the profile information pertaining to other attorney users. This page serves as an electronic contact database whereby the user can search for other members and view the member's profile. A user can search the database by a number of parameters including, for example, last name, city, state, bar number and types of law practiced. When the user searches the database, the interface sends a query to the server and displays the results based upon the parameters. The resulting names are displayed as hyperlinks. The user can select a name by clicking on the hyperlink and thus display the detailed profile of the member. This detailed profile contains information such as, for example, first name, last name, law firm, address, city, state, zip code, phone numbers, fax numbers, e-mail address as a hyperlink, law firm Web site address as a hyperlink, membership in state bars, years admitted to the corresponding state bars, bar number, bar status, types of law practiced and a photograph of the member. The hyperlinks for an attorney's profile pertaining to e-mail and Web sites allow the user to click on them resulting in the user's default Web browser or default e-mail program performing the indicated function. The page also lists results from a number of previous searches.

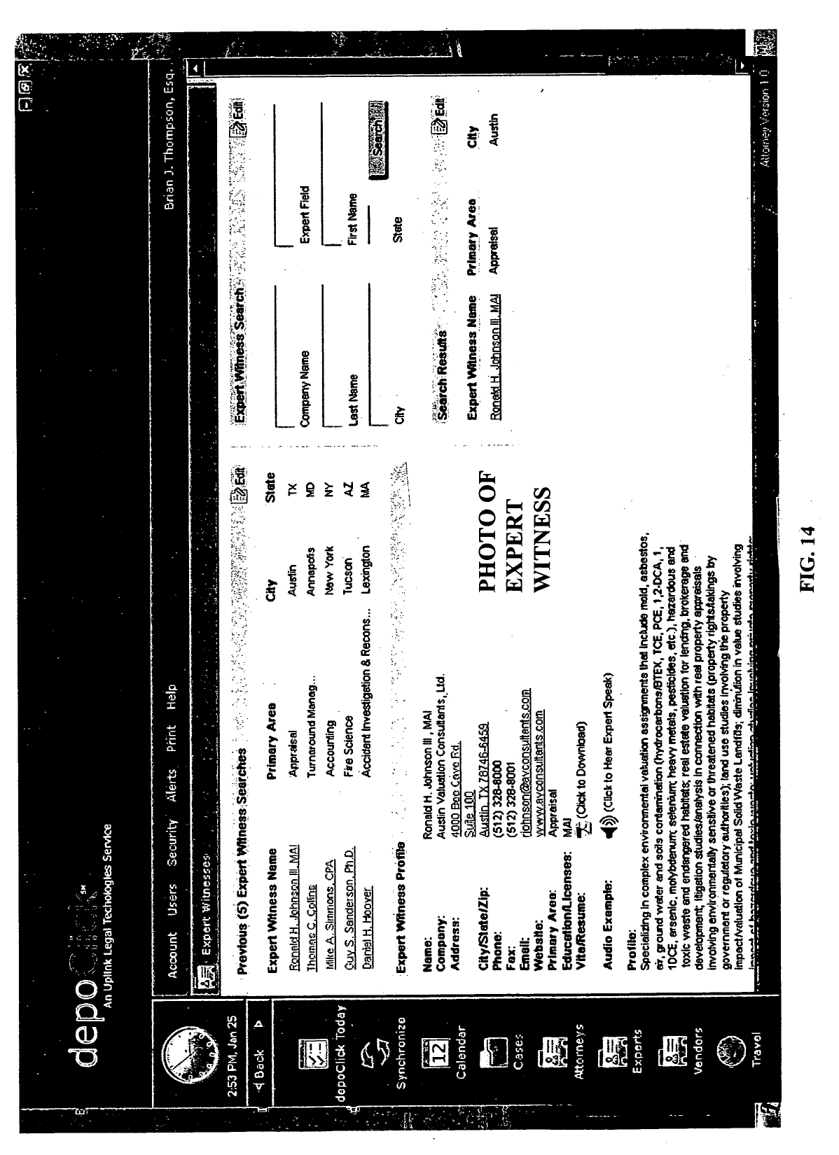

A user can access the Expert Witnesses page (FIG. 14) of the system by clicking on the appropriate button or hyperlink (found on the left side of nearly any page of the system). The Expert Witnesses page displays the profile information pertaining to other users classified as expert witnesses. This page serves as an electronic contact database whereby the user can search for expert witnesses and view their profiles. The user can search for an expert witness by certain parameters including, for example, first name, last name, city, state, expert field and company name. When the user searches the database, the interface sends a query to the server and displays the results based upon the parameters. The resulting names are displayed as hyperlinks. The user can select a name by clicking on the hyperlink and thus display the detailed profile of the expert witness. This detailed profile contains information such as, for example, first name, last name, company name, address, city, state, zip code, phone numbers, fax numbers, e-mail address as a hyperlink, company Web site address as a hyperlink, primary area of expertise, education, licenses, detailed profile of areas of expertise, a PDF or similar downloadable document of vita or resume, prior testimonies, fee schedules and a photograph of the member as well as audio and video samples. The hyperlinks for the member's profile pertaining to e-mail and Web sites allow the user to click on them resulting in the user's default Web browser or default e-mail program performing the indicated function. The page also lists results from a number of previous searches.

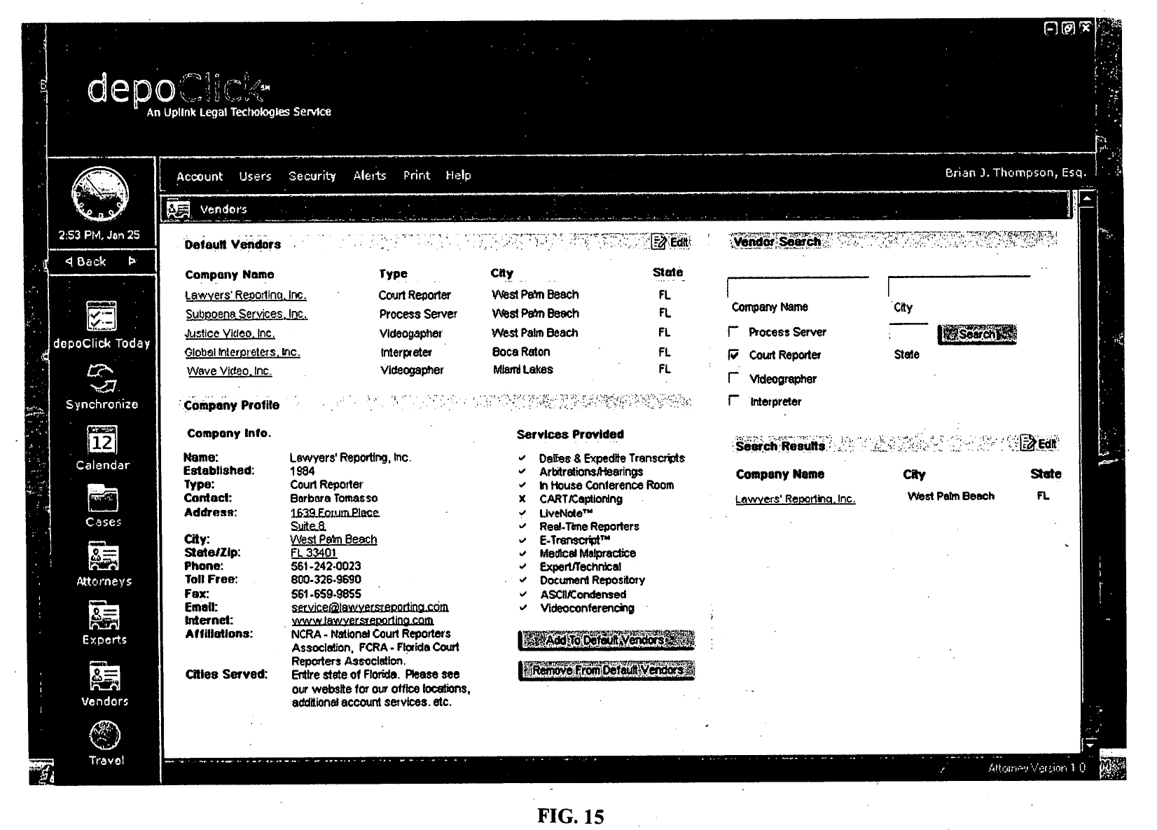

By pressing the Vendors icon found on the left side of nearly any page of the system, the user is sent to the Vendors page of the system (FIG. 15). This page displays the profile information pertaining to other users classified as vendors which includes, for example, process servers, court reporters, videographers, interpreters and staffing companies. This page serves as an electronic contact database whereby the user can search for vendors and view a vendor's profile. The user can search for a vendor by certain parameters including, for example, company name, city, state and a choice of the type of vendor as indicated above. When the user searches the database, the interface sends a query to the server and displays the results based upon the parameters. The resulting names of vendors are displayed as hyperlinks. The user can select a name by clicking on the hyperlink and thus display the detailed profile of the vendor. This detailed profile contains information such as, for example, type of vendor, company name, address, city, state, zip code, phone numbers, fax numbers, e-mail address as a hyperlink, company Web site address as a hyperlink, company logo artwork or photograph, year established, fee schedules, affiliations, cities served, services provided, and buttons or hyperlinks to add the vendor as a default vendor to the user's profile or to remove the vendor from the user's profile. The hyperlinks for the vendor's profile pertaining to e-mail and Web sites allow the user to click on them resulting in the user's default web browser or default e-mail program performing the indicated function. The page also lists results from a number of previous searches.

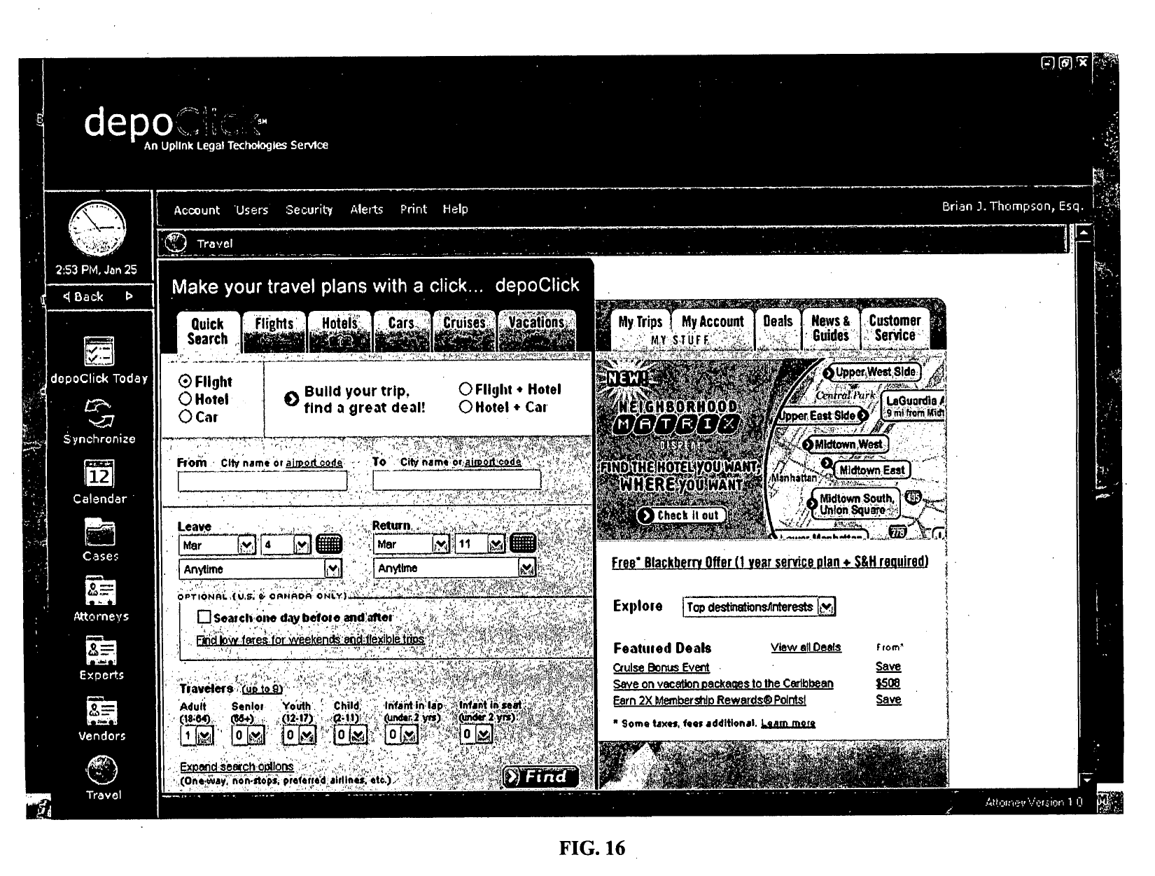

The Travel page of the system (FIG. 16) can be accessed by pressing the Travel button on the left side of any page of the system. The Travel page displays the profile information pertaining to arranging and securing travel arrangements for users attending a particular event. This page serves as an electronic gateway to an independent travel company or can be a part of the database itself. The page displays function buttons or hyperlinks whereby the user can make automobile, airplane and hotel reservations. The page may also contain hyperlinks or buttons to contact the travel company, hyperlinks to the company Web site and hyperlinks to the company's e-mail. The hyperlinks pertaining to e-mail and Web sites allow the user to click on them resulting in the user's default Web browser or default e-mail program performing the indicated function.

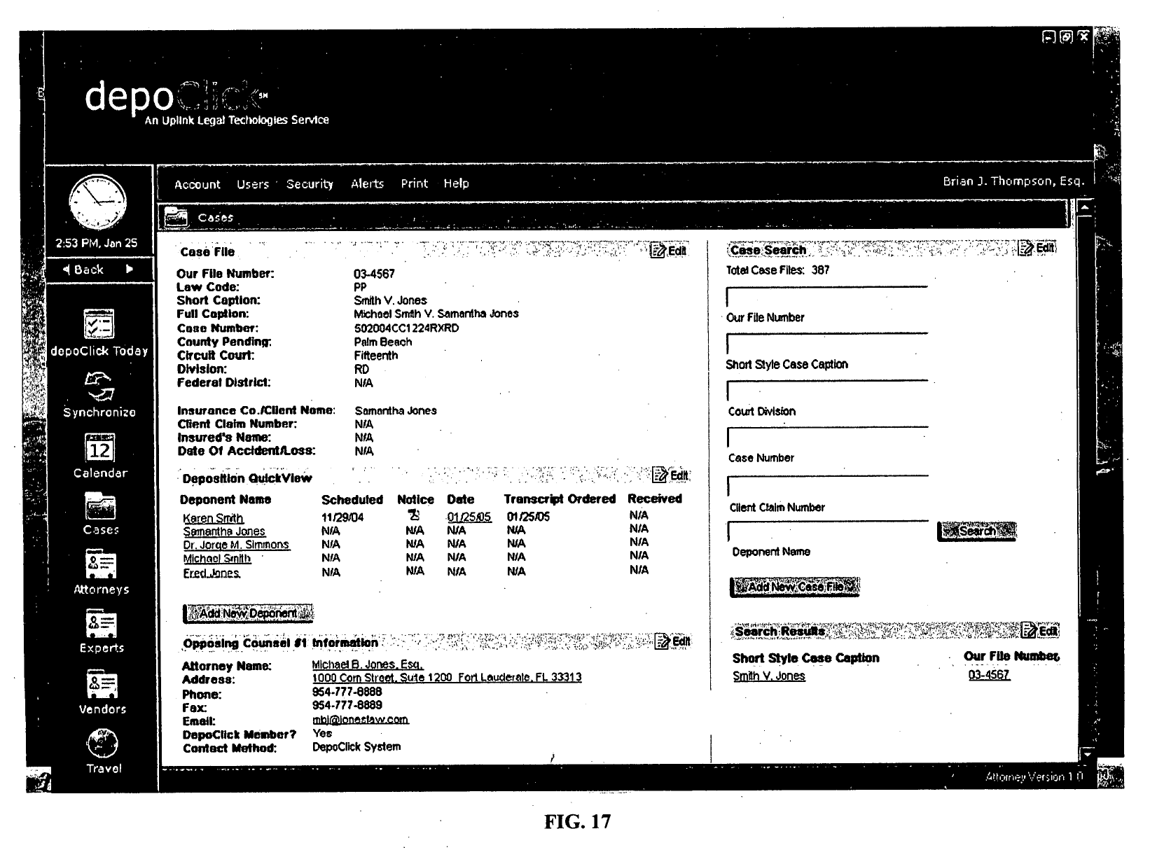

By pressing the Cases button on the left side of nearly any page of the system, a user is sent to the Cases page of the system (FIG. 17). The Cases page displays the profile information pertaining to the legal case files for the attorney user. This page serves as an electronic database whereby the user can search for his case files and detailed information for each case. The user can search the account database using certain parameters including, for example, internal file number, case caption, court division, case number, client claim number, client name and witness name to locate and view a particular case file. When the user searches the database, the interface sends a query to the server and displays the results based upon the parameters. The resulting queries are displayed as hyperlinks. The user can select a name by clicking on the hyperlink and thus display the detailed information of the corresponding case. This detailed profile contains information such as, for example, internal file number, internal law code, full case caption, short case caption, county pending, circuit court, division, federal district, insurance company, client name, insurance claim number or client claim number, insured's name, date of accident and date of loss, deponent or witness names, deposition or event scheduled status, PDF or similar documents, date of event, transcript status of event, and a button or hyperlink to add a deponent to the list.

The Cases page also displays information pertaining to the case's opposing counsel and co-counsel which can include, for example, the attorney name, law firm name, address, city, state, zip code, phone numbers, fax numbers, hyperlinks or buttons for e-mail addresses and Web site addresses, membership status (i.e., whether or not the user is a registered member of the system) and preferred contact method. The hyperlinks for the attorney member's profile pertaining to e-mail and Web sites allow the user to click on them resulting in the user's default Web browser or default e-mail program performing the indicated function. The page also lists results from a number of previous searches.

The Cases page also allows the user to create a new case file if one has not yet been created. To create a new case file, a user clicks the appropriate button or hyperlink (the Add New Case File button) and is taken to a form where the user fills in the case information listed above. When completed, the user clicks an Add Deponent or Add Witness button to add the deponents or witnesses for the case. The user is brought to a form page where the user fills in the deponent or witness' basic contact information for the person. The user can add deponents as often as he likes and is not limited to the total number of witnesses or deponents for a single case. Once the user has added witnesses or deponents to the case file, the witnesses or deponents are listed on the case page as hyperlinks. Preferably, once a case file is created it cannot be erased or deleted. However, the case file can be rendered “inactive” meaning that there is no further work to perform on this file.

The Deposition Details Of: (Deponent Name) page of FIG. 18 displays the profile information pertaining to the detailed information for the deponent or witness for the user's case file. Once the user creates a new witness or deponent, the name of the deponent or witness is displayed as a hyperlink on the Cases page (FIG. 17). The user can then click on this hyperlink to access the Deposition Details Of: (Deponent Name) Page. This page allows the user to schedule the deponent or witness for an event or service such as, for example, depositions, sworn statements under oath, unsworn statements, examinations under oath, independent medical examinations, subpoenas and subpoenas duces tecum. The page displays functions as buttons or hyperlinks to complete the necessary scheduling tasks. The page displays such data elements to aid in the scheduling tasks such as the user's internal file number, case caption, court division, case number, client claim number, client name and deponent name to aid the user in identifying the correct case file for deponent or witness he is attempting to schedule. Any of these identifiers can be hyperlinks allowing the user to view interrelated information. This allows the user to select additional data by clicking on the appropriate hyperlink and thus display additional details the user may require. The Deposition Details Of: (Deponent Name) page contains information which may be divided into sections such as the deponent contact and identifying information (e.g., internal file number, name of witness, address of witness, city of witness, state of witness, zip code of witness, phone numbers of witness, fax numbers of witness and indicator as to whether the witness is classified as an expert witness).

The Deposition Details Of: (Deponent Name) page may also contain information regarding the deposition or event information which includes any one of the types of services listed above. This page can include, for example, the process service company name, date and time the process server was ordered by the user, date and time of subpoena service on the deponent, court reporting company name, date of the event or service, time of the event or service, estimated time needed for the event, address or logistics for the event and a corresponding map to view or print driving directions to the event or service, PDF or similar XML documents which the user can view or print to obtain a copy of the proof of service or a copy of the notice for the event or service. Such documents may have a digital signature to ensure authenticity of the document.

The Deposition Details Page Of: (Deponent Name) page (FIG. 18) may further include information such as the video service company name, if the event or service was videotaped, date and time the user ordered the videotape, and its respective date of arrival to the user. Additionally, this page may also display a button or hyperlink allowing the user to order the videotape of this event or service from the video service company, the button or hyperlink transporting the user to another page to complete the ordering requirements. This page may also include information such as the interpreter or translation company name, if the event or service had an interpreter or translator, and the type of language needed. This page can also contain a mediator section which can provide notification and securing of mediation services similar to what has been described here for other services.

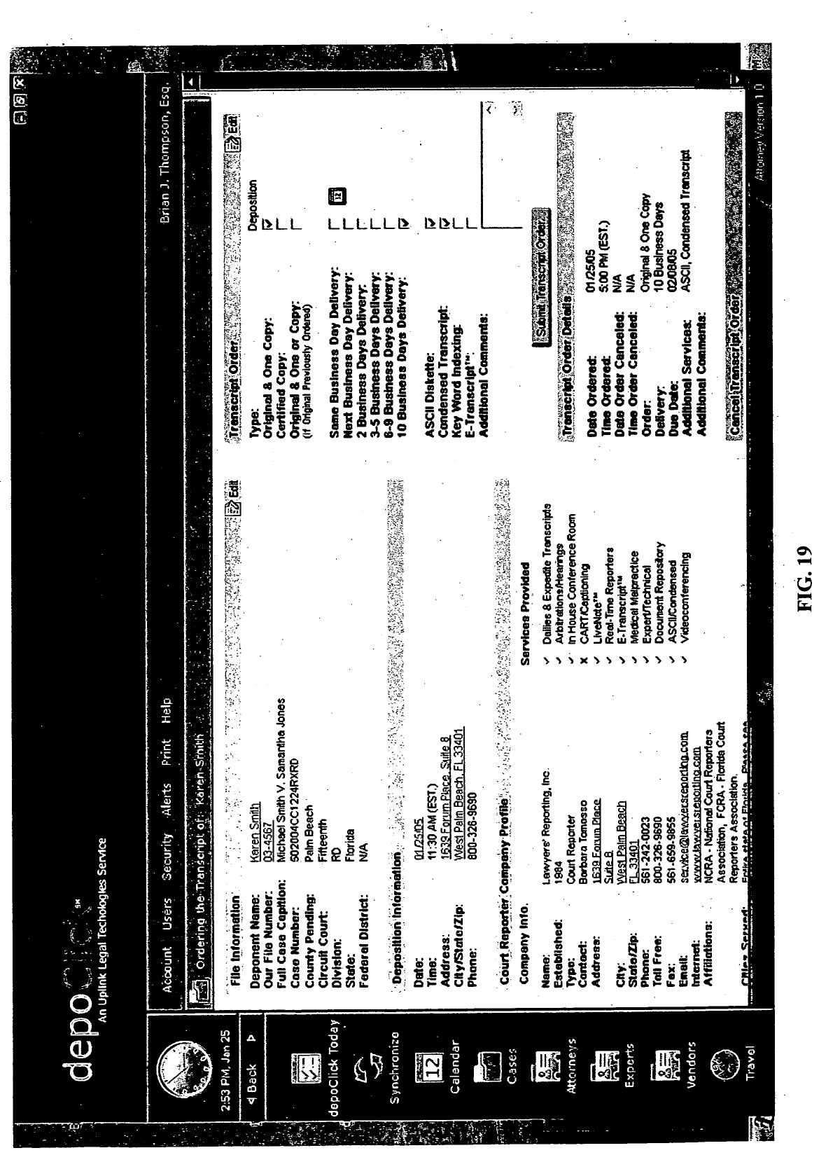

The Deposition Details Of: (Deponent Name) page can also display a button or hyperlink to send a user to the Ordering The Deposition Transcript Of: (Deponent Name) page (FIG. 19), a page for ordering transcripts. This page allows the user to order the transcript of a particular deposition from the court reporting company that performed the service. This page displays the date and time the user ordered the transcript from the court reporting company and its respective date of arrival to the user. This page contains sections such as the File Information section that contains information including the deponent name, internal file number, full case caption, case number, county pending, circuit court, division, and state and federal district. These elements of information indicate to the user that they are utilizing the correct case file. This page can also contain a section labeled Deposition Information which includes the information entered in from the Deposition Details Of: (Deponent Name) page (FIG. 18). The Deposition Information section can include, for example, the type of event, the date of an event, time of event with respective time zone, address, city, state, zip code and phone number of the event location. The Ordering The Deposition Transcript Of: (Deponent Name) page can further contain a section labeled Court Reporter Company Profile which contains similar information as indicated in FIG. 15. This section can include, for example, the court reporting company name, year established, type of vendor, contact name, address, city, state, zip code, phone numbers, fax numbers, e-mail address as a hyperlink, Web site address as a hyperlink, affiliations, cities served and the types of services provided by the vendor.

This page may also contain a section labeled Transcript Order. This section allows the user to order specific services from the vendor. This section may include information such as type of service performed for the indicated witness, the type of transcript to be ordered, i.e., original, original and one copy, certified copy, and original and two copies. This section also allows the user to select the time frame for delivery of the transcript and additional services such as ASCII diskettes, condensed/micro-transcript/mini-transcripts and e-mail/e-transcripts (e.g., Copyright Reallegal, Inc.), etc. This section may also contain a text box allowing the user to enter a text message for this order to add any additional comments regarding the order for the vendor. This section also may contain a button or hyperlink to submit the selections for the ordering of the transcript which will enter the information into the system and transmit the order to the court reporting company electronically. The Ordering The Deposition Transcript Of: (Deponent Name) page may also contain a section labeled Transcript Order Details which displays the date of the order by the user, time of order with respective time zone, date of cancellation or order, time of cancellation of order with respective time zone, details of the previously mentioned order details entered by the user and the date the user can expect delivery. This page can also contain a link to a Transcript Orders page (FIG. 23) that features transcript order delivery confirmation of transcript orders that have been placed. For example, this page can contain the date and time of delivery acknowledgement of a particular transcript order. This page can further contain a section labeled Cancel Transcript Order. This section displays a button or hyperlink allowing the user to cancel the previously ordered transcript as described previously. The Ordering The Deposition Transcript Of: (Deponent Name) page also contains buttons or hyperlinks to pages for scheduling the event or service for a particular deponent or witness.

The Deposition Details Of: (Deponent Name) Page may include a section labeled Deponent Scheduling Tools. This section can include a button or hyperlink to request a date whereby the user can click the indication function which sends a query to the database to determine the first available date and time that all of the attorneys and expert witnesses (if the deponent is classified as such) are available to attend the event or service. This section also displays the name of the attorney scheduling the service, the date and time the request was ordered by the user, and the first date and time available to all valid users as indicated above. The displayed data may be in the form of hyperlinks allowing the user to view further relevant detailed data. This section also may display the date and time confirmed by the user with respective time zones, a button or hyperlink to confirm the date and time, and dates and times where all other attorneys and expert witnesses confirmed attendance of the scheduled event or service. This section also can display the name of the user or other individual who is attending the event who has requested a rescheduling of the event or service, a button for the user to request a rescheduling of the service and the date and time of the rescheduling request. This section also can display the name of the user or other individual who has requested a cancellation of the event or service, a button for the user to request a canceling of the event or service and the date and time of the canceling request.

The Deposition Details Of: (Deponent Name) page can contain a section labeled Schedule Deponent where the user can select the type of service to schedule for the deponent, e.g., deposition, sworn statement, etc. This is performed after the requested date and time for all users are returned by the system server after the user has clicked a button or hyperlink querying the server to analyze all the respective users calendars for open dates and times for this particular case file from the Deponent Scheduling Tools section. After the appropriate calculation, the system displays the first available date and time for all authorized users. The user can then enter an address, city, state, zip code, phone number and contact name for the location of the event or service if the user is satisfied with first available date and time the system has displayed as a result of the query. This section can also provide other text comments that the user may wish to express to individuals attending a particular event such as conference call numbers or access codes for conference calls.

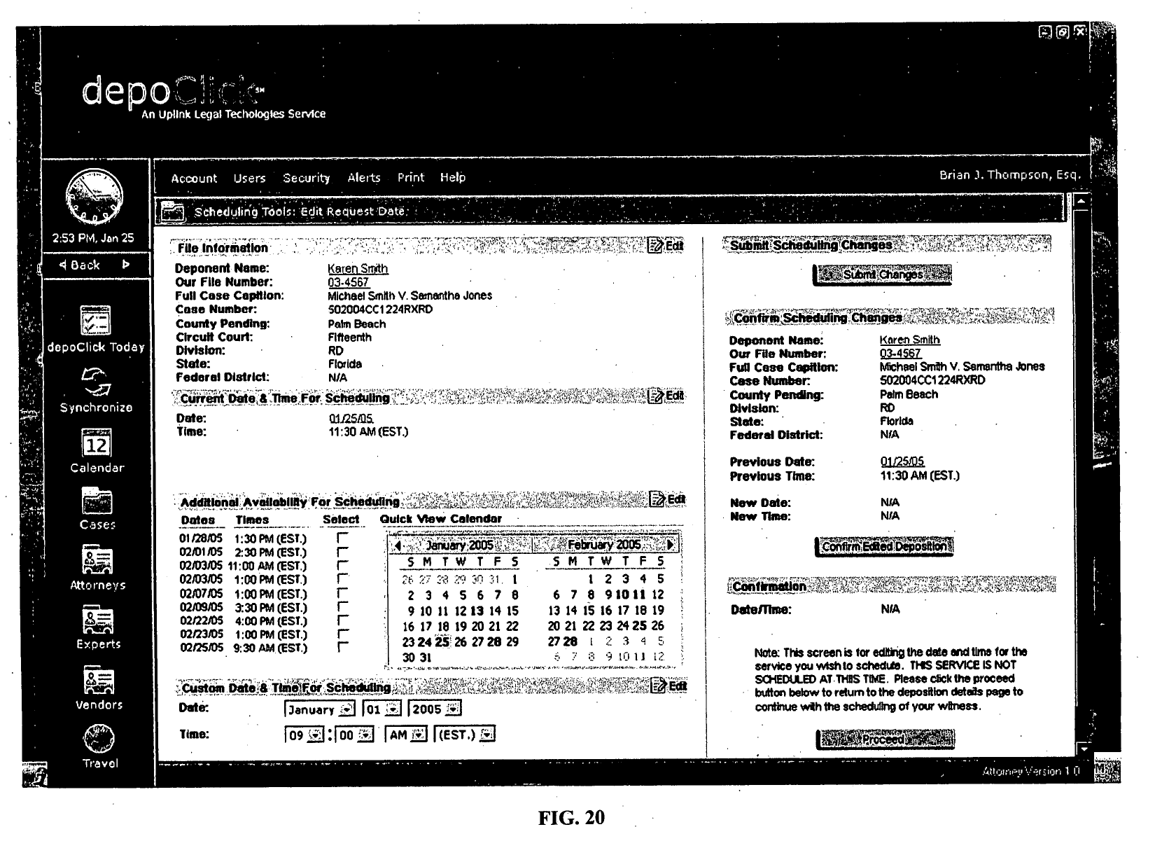

The Deponent Scheduling Tools: Edit Request Date page of FIG. 20 allows the user to edit the requested date and time for an event or service for the indicated deponent or witness from the Deposition Details Of: (Deponent Name) page. The Deponent Scheduling Tools: Edit Request Date page allows the user to edit a deponent or witness event or service when initially being scheduled or allows the user to perform functions when rescheduling a witness or deponent. To access this page, a user clicks the appropriate button or hyperlink (labeled Edit Request Date) on the Deposition Details Of: (Deponent Name) page (FIG. 18). The Deponent Scheduling Tools: Edit Request Date page displays functions as buttons or hyperlinks to complete the necessary scheduling tasks. This page contains sections such as File Information that contains information including, for example, the deponent or witness name, internal file number, full case caption, case number, county pending, circuit court, division, and state and federal district. This page may also contain a section labeled Current Date and Time For Scheduling which may display data such as date of the service or event and the time of the service or event with respective time zone.

This page can further contain a section labeled Additional Availability For Scheduling. This section can contain a listing of all available dates for an event or service whereby the user has sent a request by clicking on a button or hyperlink which requests the query from the server. The server checks the calendars of the attorneys and expert witnesses or mediators and searches for available dates and times for the services or events. The server then transmits the data back to the user displaying a list of the results. The user can select an available date and time from this listing. This section may also contain a calendar interface that provides the user with an overview of dates and their corresponding events. This page may also contain a section labeled Custom Date and Time For Scheduling. This section allows the user to manually enter a date and time for the event regardless of the availability based upon the server's query results. The user can select dates and times from the available list or enter a date and time manually. This is helpful in the event a service has many witnesses or deponents but only requires minimal time between services and thus alleviates the user from requesting additional dates and times for availability from the database server.

This page can also contain a section labeled Submit Scheduling Changes. This section may contain a hyperlink or button for submitting the indicated date and time pertaining to a particular deponent or witness within the browser or user interface and displaying this information on this page for confirmation at a later time. This page can also contain a section labeled Confirm Scheduling Changes. This section displays the data from the previous sections on this page such as the case information, deponent name and selected date and time for the event or service for the user to review and confirm the scheduling task. This section can further include the data indicators for rescheduling a previously scheduled service and a button or hyperlink for confirming the scheduling task. This page can also contain a section labeled Confirmation. This section can display, for example, the date and time the user confirmed the previous schedule by clicking the Confirm Edited Deposition button or hyperlink in the previous section. The Submit Changes button displays the changes by the user by displaying the user's changes on the same screen in the Confirm Scheduling Changes section. The user reviews it and if satisfied, clicks the Confirm Edited Deposition button.

The section labeled Confirmation simply displays the date and time the user clicked the Confirm Edited Deposition button. This information preferably remains so the user always knows when they made that confirmation of changes. At this point, the service for the event on the date and time is not scheduled with counsel, expert witness, mediators, or vendors. This section can additionally contain text explaining that the event is not currently scheduled and that further steps are necessary to complete the scheduling process. This section is to confirm the date and time for the event or service by the user to continue the scheduling process. This section can also contain a button or hyperlink (labeled Proceed in FIG. 20) that allows the user to proceed with the changes he made and be returned to the previous Deposition Details Of: (Deponent Name) page. When the user clicks the button or hyperlink to proceed and is returned to the Deposition Details Of: (Deponent Name) page, the date and time the user has edited and ultimately selected has now become the date and time the user will schedule for the event. The user then proceeds by completing the Schedule Deponent section as indicated in the Deposition Details Of: (Deponent Name) page (FIG. 18).

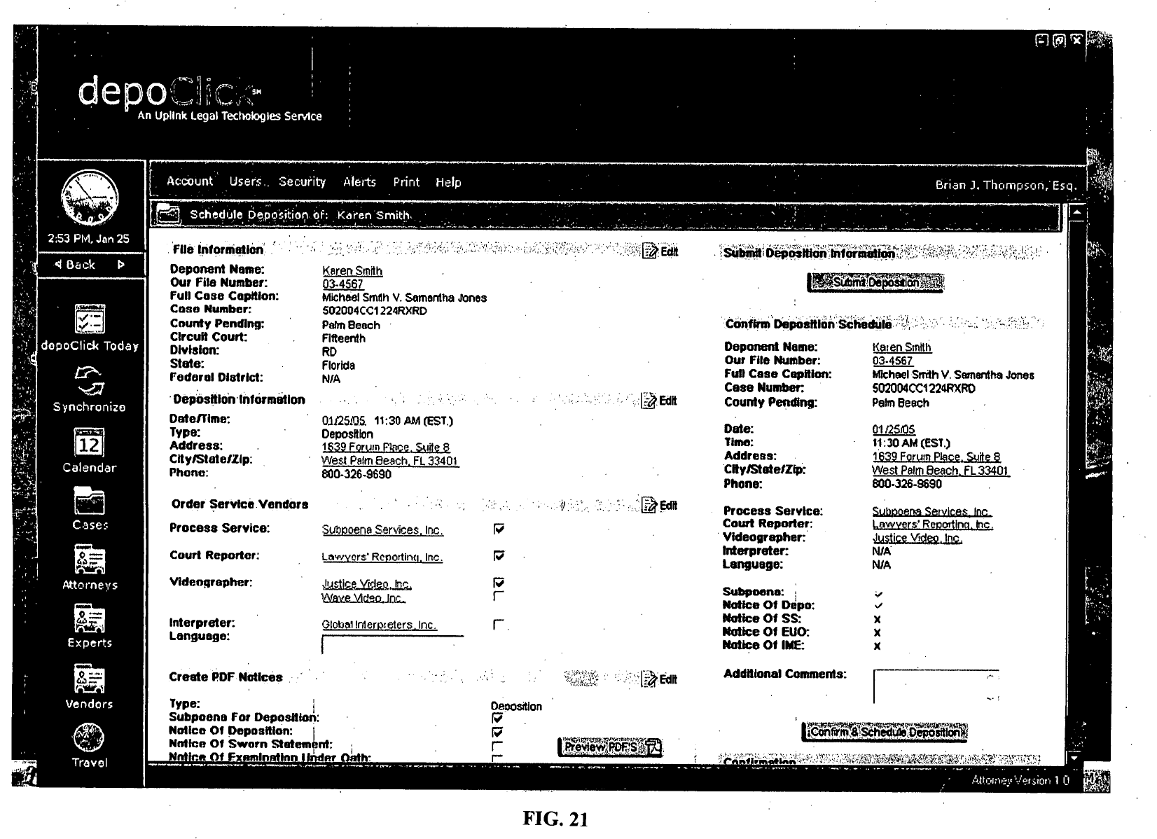

The user completes the information necessary for scheduling the event by selecting the type of service (e.g., deposition, sworn statement, mediation, etc.) from a menu list and typing text such as the address, city, state, zip code, phone number and estimated time for the event into a form on the page. When the user has completed the information for scheduling by completing the Schedule Deponent section, the user clicks the appropriate button or hyperlink (labeled Schedule Depo in FIG. 18) that submits the information and transports the user to the next page where the user can complete the scheduling task (FIG. 21).

The Schedule Deposition Of: (Deponent Name) page of FIG. 21 displays the final tasks required for the scheduling of the deponent or witness. The information shown on this page is dependent upon the user indicating or selecting elements from previous pages. To connect to this page, the user clicks on the appropriate button (the Schedule Depo button of FIG. 18). The Schedule Deposition Of: (Deponent Name) page displays functions as buttons or hyperlinks to complete the necessary scheduling tasks. This page displays information to aid in scheduling tasks such as the File Information section that includes, for example, the deponent name, internal file number, full case caption, case number, county pending, circuit court, division, and state and federal district. These elements of information indicate to the user that they are utilizing the correct case file. These elements of information are integrated using XML or similar technologies into the electronic documents such as notices of deposition, and subpoenas, etc., that are to be transmitted to all necessary vendors, attorneys and expert witnesses. These documents may contain a digital signature to ensue authenticity.

This page can also contain a section labeled Deposition Information which includes the information entered in on the Deposition Details Of: (Deponent Name) page (FIG. 18). This section may include information such as date of event, time of event with respective time zone, address, city, state, zip code and phone number of the event location. This page can also contain a section labeled Order Service Vendors. This section allows the user to select vendors needed for the service or event to occur. These vendors may include process servers, court reporters, videographers, interpreters/translators and mediators. Once the user selects any and all vendors needed for this particular service or event, the vendors listed on this section are listed as hyperlinks allowing the user to view the vendor's member profile. The translator/interpreter vendor selection also allows the user to select or input the type of language required. This page can also contain a section labeled Create Notices or Create PDF Notices or Documents. This section allows the user to electronically insert the database text elements of the case and the event logistics (e.g., date, time, location, etc.) by use of XML or similar technologies into electronic documents that include, for example, subpoenas, letters of sworn statements, examination under oaths, unsworn statements, notices of deposition, notices of independent medical examinations and subpoena duces tecum. Such documents may have a digital signature to ensure authenticity of the electronic document. The user can create, save, edit, delete, import or export these electronic documents for XML database integration within the system. The system displays the name of each electronic document that is available to the user as plain text or as a hyperlink. The user selects any and all electronic documents by clicking the checkbox (or by using another similar method of identification) next to the corresponding document name to insert the case database elements into that particular document. Typically, the data from the case file is inserted into pre-constructed letters by the user. The user only has to create these templates once. The user then selects a document, such as a notice of deposition, and the case data is automatically inserted into the template, thereby creating the document quickly and mistake free. These electronic documents are sent to the respective attorneys, expert witnesses and vendors electronically along with the electronic data which is displayed upon their respective graphical user interfaces.

The Schedule Deposition Of: (Deponent Name) page can also contain a section labeled Submit Deposition Information. This section allows the user to confirm the case information, the date and time for the event or service, the vendors selected, and the electronic documents to be created using the database elements as previously described allowing the user to continue the scheduling process. This section may contain a button or hyperlink to submit and process the previous pages sections of data and display them in another section for review on this same page in a section labeled Confirm Deposition Schedule. This Confirm Deposition Schedule section contains the data elements displayed as a result of the user clicking the submit button on the previous section. This page allows the user to review all the elements for the scheduled service and event. This section can also contain a button or hyperlink to confirm and submit the data elements to the main server and thus distribute the data to the server. The server routes the data and the corresponding documentation to the appropriate users (e.g., attorneys, expert witnesses, judges, mediators, process servers, court reporters, videographers and interpreters/translators). This page can also contain a section labeled Confirmation. This section can display, for example, the date and time the user confirmed the previous section and thus officially scheduled the event or service.

### EXAMPLES

### Example 1

### Workflow of Software

A.) Attorney “A” informs assistant “A” (scheduling assistant) that he wishes to schedule the deposition of witness “X” in case “Y.”

B.) Assistant “A” clicks on the software icon on the desktop computer to activate the system browser which connects to the server via the Internet where the server validates attorney “A's” account information.

C.) Assistant “A” selects the case name using the graphical user interface or creates a new case file if needed. If creating a new case file, Assistant “A” enters the complete case caption, case number, presiding Judge, case division, county of file and state, etc. When creating a new case file, assistant “A” will select the legal service providers or select the default legal service providers that they entered when attorney “A's” account was created.

D.) Assistant “A” will then select the opposing counsel and/or co-counsel (receiving attorneys) for the case from the directory available from the database at the server.

E.) Assistant “A” enters the name of witness “X” into the user interface for case “Y” and saves it. Assistant “A” selects witness “X” from the list of witnesses for case “Y.” Assistant “A” then enters the duration and location for the event of witness “X” and selects the “Check Availability” button.

F.) Witness “X's” information for case “Y” is sent to the database through a graphical user interface via the Internet. The database program checks the calendars of attorney “A,” attorney “B,” attorney “C,” etc., and provides the first available date and time that all attorneys would be able to attend based upon the database results. Assistant “A” can also select from a listing of available dates and times or enter a specific date and time regardless of the database authorization for availability.

G.) The availability results are sent back to assistant “A” through the database server and displayed on the graphical user interface. It also denotes the dates and times that was selected by the database as available for all parties.

H.) Assistant “A” reviews the dates and if satisfied with the proposed scheduling possibilities, clicks the “Send to all counsel” button on the user interface. The three proposed dates, times and locations of witness “X” for case “Y” are sent to all counsel listed on the case via the database via the Internet.

I.) Each attorney's graphical user interface is updated and notifies the user via verbal and audio signals as to new proposed event dates. Once each proposed event date is reviewed by other counsel, the database is updated and notifies the scheduling attorney the time and date that the receiving attorney accessed the proposed information.

J.) Each receiving attorney will then check the availability of their schedule and if they are able to attend as the database has indicated, the users click “Okay to schedule” button on their graphical user interface. The acknowledgement information is transmitted through the graphical user interface to the database via the Internet where it updates and notifies all other counsel by visual and audio signals as to the confirmation. If the attorney realizes that they will not be able to attend, even though the database indicates otherwise, the user clicks “Please try another date” button. The information is sent to the database as described above and the information is sent to all attorneys. The scheduling attorney would start the process again by selecting “Okay to schedule” button to obtain the next possible dates that are available by all attorneys.

K.) Once an acceptable date and time for the event has been determined by assistant “A,” the assistant then clicks on the check boxes to notify the legal service providers of the scheduled event and clicks the check boxes next to the legal XML database integrated documents to be assembled by the system and notify all the parties via the database.

L.) All information for the event of witness “X” for case “Y” such as witness name, case caption, case number, presiding judge, case, division, county of case, state, date, time and location is sent through the graphical user interface to the database via the Internet to the selected legal service providers.

M.) The legal service providers are notified through their graphical user interfaces by visual and audio signals that new event information has arrived.

### Example 2

### Scenario of Events in Legal Scheduling

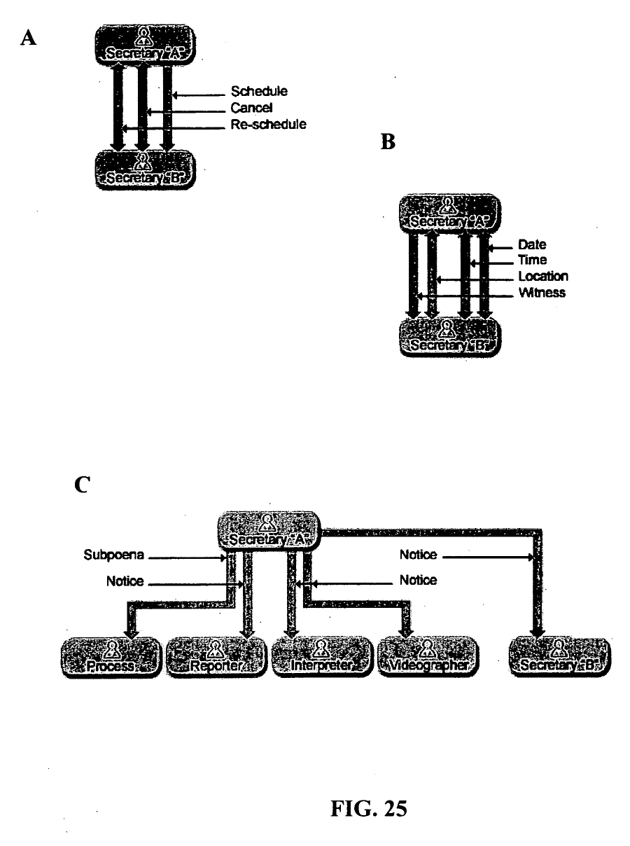

Referring to FIG. 25A, in overview, the primary reason that the interaction takes place between two secretaries is to coordinate the logistics for an event such as a deposition, sworn statement, mediation, etc. Scheduling is the ultimate goal, but the possibility remains that the event could cancel.

Referring to FIG. 25B, a common application for the system of the invention involves coordinating. In such an application, the scheduling secretary (e.g., attorney's assistant) must coordinate with other counsel and possibly expert witnesses as to the date, time and location for the event to occur.

Referring to FIG. 25C in a step of notifying, once the event is scheduled, the secretary formally notifies the vendors and counsel of the event. The secretary may be required to notify the process server, court reporter, interpreter and videographer.

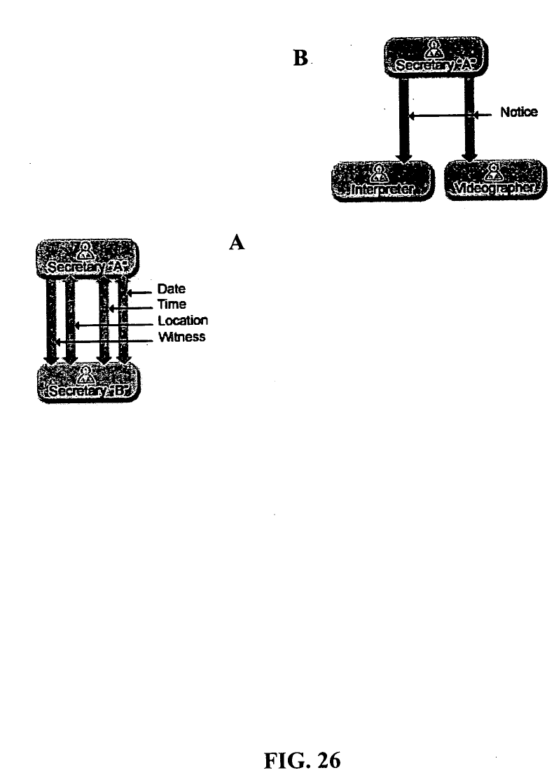

Referring to FIG. 26A, the system of the invention is designed to resolve changes that need to be made. For example, after the vendors and counsel are notified of the event, there can and often are changes to the event such as the time, date, location and sometimes even the witness. Usually when the witness is changed, it is a result of the attorneys wanting to keep a deposition on because it is conducive to both of their immediate schedules.

Referring to FIG. 26B, after the event has been coordinated and counsel and vendors notified, it may be necessary to add additional services such as an interpreter to help with language disparities or videotaping of the event.

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A system for scheduling a deposition of a witness during a litigation, the: system comprising:
at least one server communicatively connected to a computer communications network,
the at least one server comprising at least one database having stored therein data relating to the witness deposition,
the data comprising (a) the name of an attorney or law firm representing a plaintiff in the litigation, (b) the name of an attorney or law firm representing a defendant in the litigation, (c) information identifying the litigation, (d) the name of the witness, and (e) a proposed date and time for conducting the witness deposition,
the at least one server configured to receive input signals from and transmit output signals across the computer communications network to a network access device of at least a first system user acting for the attorney or law firm representing a defendant and to a network access device of a second system user acting for the attorney or law firm representing a plaintiff,
wherein at least a portion of the data stored in the database, including the proposed date and time for conducting the witness deposition, can be modified by the first system user and the second system user via the input signals conveyed across the computer communications network,
wherein the server further comprises at least one database having stored therein the calendar schedules of a plurality of attorneys comprising at least the attorney representing a plaintiff and the attorney representing a defendant,
the system further comprising a processor configured to compare the calendar schedules of a plurality of attorneys and determine at least one date and time that all of the plurality of attorneys are available to attend the witness deposition.

2. The system of claim 1, wherein the processor is configured to compare the calendar schedules of a plurality of attorneys and determine at least three dates and times that all of the plurality of attorneys are available to attend the witness deposition.

3. The system of claim 1, wherein the processor is configured to register a new user of the system and to restrict unregistered users from accessing the system.

4. The system of claim 1, wherein the processor is configured to compare a digital signature stored on the database with a digital signature on a document to determine authenticity of the document.

5. The system of claim 1, wherein the processor is configured to export and synchronize data and files stored in the database with other servers communicatively connected to the computer communications network.

6. The system of claim 5, wherein the processor is configured to import data and files stored in a database on at least one of the other servers.

7. The system of claim 1, wherein the processor is configured to send a signal to a user's network access device indicating that a change has been made to the proposed date and time for conducting the witness deposition.

8. The system of claim 1, wherein the processor is configured to synchronize with a calendaring software program resulting in information pertaining to a particular user stored in the database being updated when that user logs on to the system.

9. A system for scheduling a deposition of a witness during a litigation, the system comprising:
at least one server communicatively connected to a computer communications network,
the at least one server comprising at least one database having stored therein data relating to the witness deposition,
the data comprising (a) a name of an attorney or law firm representing a plaintiff in the litigation, (b) a name of an attorney or law firm representing a defendant in the litigation, (c) information identifying the litigation, (d) a name of the witness, (e) a proposed date and time for conducting the witness deposition, and (f) a proposed location for conducting the deposition,
the at least one server being configured to receive input signals from and to transmit output signals across the computer communications network to a network access device of at least a first system user acting for the attorney or law firm representing a defendant and a network access device of a second system user acting for the attorney or law firm representing a plaintiff,
wherein at least a portion of the data stored in the database, including the proposed date and time for conducting the witness deposition, can be modified by the first system user and the second system user via the input signals conveyed across the computer communications network.

10. The system of claim 9, wherein the at least one server is configured to receive input signals from and transmit output signals to a network access device of at least one additional system user selected from the group consisting of: an expert witness, a mediator, a judge, a judicial assistant, a court clerk, a process server, a court reporter, a videographer, and an interpreter.

11. The system of claim 10, wherein the at least one additional system user comprises a vendor selected from the group consisting of: the court reporter, the process server, the videographer, the interpreter, and the mediator.

12. The system of claim 10, wherein the at least one additional system user comprises a court official selected from the group consisting of: the judge, the judicial assistant, and the court clerk.

13. The system of claim 10, wherein the at least one server is further configured to receive input signals from and transmit output signals to a network access device of an insurance company representative.

14. The system of claim 9, wherein the computer communications network is the Internet and the first system user is located at least 1 kilometer from the second system user.

15. The system of claim 9, wherein the data stored in the database further comprises at least three selected from the group consisting of: (g) the name of the presiding judge, (h) contact information for the attorney representing a plaintiff, (i) contact information for the attorney representing a defendant, (j) the name of the court at which the litigation is pending, (k) the address of the court, (l) official court documents relating to the litigation, and (m) a law firm's internal file number pertaining to the litigation, the law firm representing a plaintiff in the litigation or a defendant in the litigation.

16. The system of claim 9, wherein the data stored in the database further comprises at least one selected from the group consisting of: (m) directions to the proposed location of the deposition and (n) a map of an area surrounding the proposed location of the deposition.

17. The system of claim 9, wherein the data stored in the database further comprises forms for use in the litigation.

18. The system of claim 9, wherein the data stored in the database further comprises rules of practice that relate to the litigation.

19. The system of claim 9, wherein the server further comprises at least one database having stored therein compilations of (a) names of at least 100 attorneys, (b) contact information for the attorneys, and (c) areas of practice for the attorneys.

20. The system of claim 9, wherein the server further comprises at least one database having stored therein compilations of (a) names of at least 15 expert witnesses, (b) contact information for the expert witnesses, and (c) areas of expertise of the expert witnesses.

21. The system of claim 9, wherein the server further comprises at least one database having stored therein the calendar schedules of a plurality of attorneys, the plurality comprising at least the attorney representing a plaintiff and the attorney representing a defendant.

22. The system of claim 21, wherein the database has further stored therein the calendar schedule of at least one expert witness.

23. A method for scheduling a witness deposition, the method comprising the steps of:
(a) providing at least one server communicatively connected to a computer communications network,
the at least one server comprising at least one database configured to store data relating to the witness deposition, the data comprising (i) a name of an attorney or law firm representing a plaintiff in the litigation, (ii) a name of an attorney or law firm representing a defendant in the litigation, (iii) information identifying the litigation, (iv) a name of the witness, (v) at least one proposed date and time for conducting the witness deposition, and (vi) a proposed location for conducting the deposition,
the at least one server being configured to receive input signals from and to transmit output signals across the computer communications network to a network access device of at least a first system user acting for the attorney or law firm representing a defendant and a network access device of a second system user acting for the attorney or law firm representing a plaintiff, wherein at least a portion of the data stored in the database, including the proposed date and time for conducting the witness deposition, can be modified by the first system user and the second system user via the input signals conveyed across the computer communications network;
(b) accepting at the server an input signal transmitted across the communications network from the first system user, the input signal comprising data including (i) the name of an attorney or law firm representing a plaintiff in the litigation, (ii) the name of an attorney or law firm representing a defendant in the litigation, (iii) the information identifying the litigation, and (iv) the name of the witness, and storing the data comprised in the input signal in the database;
(c) transmitting from the server an output signal comprising the data comprised in the input signal and the at least one proposed date and time for the witness deposition across the communications network to the second system user; and
(d) accepting at the server input signals across the computer communications network from the second system user, and modifying the data stored in the database in accord with the input signals from the second system user.

24. The method of claim 23, wherein the at least one server is configured to receive input signals from and transmit output signals to a network access device of at least one additional system user selected from the group consisting of: an expert witness, a mediator, a judge, a judicial assistant, a court clerk, a process server, a court reporter, a videographer, and an interpreter.

25. The method of claim 24, wherein the at least one additional system user comprises a vendor selected from the group consisting of: the court reporter, the process server, the videographer, the interpreter, and the mediator.

26. The method of claim 24, wherein the at least one additional system user comprises a court official selected from the group consisting of: the judge, the judicial assistant, and the court clerk.

27. The method of claim 24, wherein the at least one server is further configured to receive input signals from and transmit output signals to a network access device of an insurance company representative.

28. The method of claim 23, wherein the computer communications network is the Internet and the first system user is located at least 1 kilometer from the second system user.

29. The method of claim 23, wherein the data stored in the database further comprises at least three selected from the group consisting of: (g) the name of the presiding judge, (h) contact information for the attorney representing a plaintiff, (i) contact information for the attorney representing a defendant, (j) the name of the court at which the litigation is pending, (k) the address of the court, (l) official court documents relating to the litigation, and (m) a law firm's internal file number pertaining to the litigation, the law firm representing a plaintiff in the litigation or a defendant in the litigation.

30. The method of claim 29, wherein the data stored in the database further comprises at least one selected from the group consisting of: (n) directions to the proposed location of the deposition, and (o) a map of an area surrounding the proposed location of the deposition.

31. The method of claim 23, wherein the data stored in the database further comprises forms for use in the litigation.

32. The method of claim 23, wherein the data stored in the database further comprises rules of practice that relate to the litigation.

33. The method of claim 23, wherein the server further comprises at least one database having stored therein compilations of (a) names of at least 100 attorneys, (b) contact information for the attorneys, and (c) areas of practice for the attorneys.

34. The method of claim 23, wherein the server further comprises at least one database having stored therein compilations of (a) names of at least 15 expert witnesses, (b) contact information for the expert witnesses, and (c) areas of expertise of the expert witnesses.

35. A method for scheduling a witness deposition, the method comprising the steps of:
(a) providing at least one server communicatively connected to a computer communications network,
the at least one server comprising at least one database configured to store data relating to the witness deposition, the data comprising (i) a name of an attorney or law firm representing a plaintiff in the litigation, (ii) a name of an attorney or law firm representing a defendant in the litigation, (iii) information identifying the litigation, (iv) a name of the witness, (v) at least one proposed date and time for conducting the witness deposition, and (vi) a proposed location for conducting the deposition,
the at least one server being configured to receive input signals from and to transmit output signals across the computer communications network to a network access device of at least a first system user acting for the attorney or law firm representing a defendant and a network access device of a second system user acting for the attorney or law firm representing a plaintiff, wherein at least a portion of the data stored in the database, including the proposed date and time for conducting the witness deposition, can be modified by the first system user and the second system user via the input signals conveyed across the computer communications network;
wherein the server further comprises at least one database having stored therein the calendar schedules of a plurality of attorneys comprising at least the attorney representing a plaintiff and the attorney representing a defendant, and a processor configured to compare the calendar schedules of the plurality of attorneys and determine at least one date and time that all of the plurality of attorneys are available to attend the witness deposition;
(b) accepting at the server an input signal transmitted across the communications network from the network device of the first system user, the input signal comprising data including (i) the name of an attorney or law firm representing a plaintiff in the litigation, (ii) the name of an attorney or law firm representing a defendant in the litigation, (iii) the information identifying the litigation, and (iv) the name of the witness, and storing the data comprised in the input signal in the database;
(c) comparing the calendar schedules of the plurality of attorneys and determining at least one date and time that all of the plurality of attorneys have available to attend the witness deposition; and
(d) transmitting from the server across the computer communications network to network access devices of the plurality of attorneys output signals comprising the at least one date and time that all of the plurality of attorneys have available to attend the witness deposition.

36. The method of claim 35, further comprising the steps of (e) accepting at the server an input signal transmitted across the computer communications network from the network access device of at least one attorney of the plurality of attorneys, the input signal comprising an indication that the at least one attorney is unable to attend the witness deposition on the at least one date and at the at least one time and a request from the at least one attorney for a rescheduling of the witness deposition; (f) transmitting from the server across the computer communications network to network access devices of the plurality of attorneys output signals comprising the indication that the at least one attorney of the plurality of attorneys is unable to attend the witness deposition and the request by the at least one attorney of the plurality of attorneys to reschedule the witness deposition; (g) comparing the calendar schedules of the plurality of attorneys and determining at least a second date and time that all of the plurality of attorneys have available to attend the witness deposition; and (h) transmitting from the server across the computer communications network to network access devices of the plurality of attorneys output signals comprising the at least second date and time that all of the plurality of attorneys have available to attend the witness deposition.

37. The method of claim 35, further comprising the steps of (e) accepting at the server an input signal transmitted across the computer communications network from the network access device of at least one attorney of the plurality of attorneys, the input signal comprising a request from the at least one attorney to cancel the witness deposition; and (f) transmitting from the server across the computer communications network to network access devices of the plurality of attorneys output signals comprising the request by the at least one attorney of the plurality of attorneys to cancel the witness deposition.
